(19) United States
(12) Patent Application Publication
(10) Pub. No.: US 2024/0302956 A1
(43) Pub. Date: Sep. 12, 2024

(54) Methods and Devices for Presenting a Keyboard Having Separate Alphabetic and Special Character Sections on a User Interface

(71) Applicant: Motorola Mobility LLC, Chicago, IL (US)

(72) Inventors: Marison Ranieri Rodrigues de Freitas, Recife (BR); Sushil Garg, Sunnyvale, CA (US); Amit Kumar Agrawal, Bangalore (IN); Janine S. Oliveira, Palo Alto, CA (US)

(21) Appl. No.: 18/118,861

(22) Filed: Mar. 8, 2023

(51) Int. Cl. G06F 3/04886; G06F 3/04847

(52) U.S. Cl. CPC G06F 3/04886; G06F 3/04847

(57) ABSTRACT

An electronic device includes a user interface configured to display content and receive user input. One or more processors operable with the user interface cause the user interface to display a virtual keyboard that includes a first section having a first plurality of virtual keys corresponding to a plurality of alphabetic characters and a second section having a second plurality of virtual keys corresponding to a plurality of special characters. The first section and the second section are separated by a translatable slider. The translatable slider can be manipulated, manually or automatically, to increase the area occupied by the first section, thereby revealing more virtual keys corresponding to more alphabetic characters, or alternatively to increase the area occupied by the second section to reveal more virtual keys corresponding to more special characters.

### BACKGROUND

### Technical Field

This application generally relates user interfaces for an electronic device, and more particularly to methods and systems for presenting and modifying the display of virtual keyboards on a user interface of an electronic device.

### Background Art

Many modern electronic devices, examples of which include smartphones and tablet computers, include essentially no keys or buttons. To the contrary, they boast large touch-sensitive displays that receive user input in the form of touch input. To make data entry simpler, these devices are generally capable of displaying virtual keyboards. A user can then touch the virtual keys of the virtual keyboard to enter alphanumeric characters,

The virtual keyboards can frequently adapt as a function of device orientation. Illustrating by example, a device may present a virtual QWERTY keyboard having one size when the electronic device is in a portrait orientation. By contrast, a virtual QWERTY keyboard having another size can be displayed when the electronic device is in a landscape orientation. While the differences in overall size may change the size of individual keys the virtual keyboard itself remains the same regardless of the size.

Virtual keyboards come in many different types. Using English keyboards as an example, there are many different types of QWERTY keyboards. These include a 35-key virtual keyboard, a 60-key virtual keyboard, and a 101-key virtual keyboard. Different numeric virtual keyboard can be included, examples of which include the 12-key Bell and the 17-key calculator, in addition to others. While switching between virtual keyboard types can occur, it generally requires a user accessing separate menu or selection functions, menus, control settings, and the like. This multiple step operation and is time-consuming, tedious, and just plain boring. It would be advantageous to have an improved virtual keyboard for electronic devices.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present disclosure.

FIG. 1 illustrates one explanatory user interface for an electronic device in accordance with one or more embodiments of the disclosure.

FIG. 2 illustrates another explanatory user interface for an electronic device in accordance with one or more embodiments of the disclosure.

FIG. 3 illustrates still another explanatory user interface for an electronic device in accordance with one or more embodiments of the disclosure.

FIG. 4 illustrates yet another explanatory user interface for an electronic device in accordance with one or more embodiments of the disclosure.

FIG. 5 illustrates another explanatory user interface for an electronic device in accordance with one or more embodiments of the disclosure.

FIG. 6 illustrates another explanatory user interface for an electronic device in accordance with one or more embodiments of the disclosure.

FIG. 7 illustrates one explanatory electronic device configured in accordance with one or more embodiments of the disclosure.

FIG. 8 illustrates one or more method steps in accordance with one or more embodiments of the disclosure.

FIG. 9 illustrates one or more method steps in accordance with one or more embodiments of the disclosure.

FIG. 10 illustrates one or more method steps in accordance with one or more embodiments of the disclosure.

FIG. 11 illustrates one or more method steps in accordance with one or more embodiments of the disclosure.

FIG. 12 illustrates one or more method steps in accordance with one or more embodiments of the disclosure.

FIG. 13 illustrates one or more method steps in accordance with one or more embodiments of the disclosure.

FIG. 14 illustrates various embodiments of the disclosure.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present disclosure.

### DETAILED DESCRIPTION OF THE DRAWINGS

Before describing in detail embodiments that are in accordance with the present disclosure, it should be observed that the embodiments reside primarily in combinations of method steps and apparatus components related to presenting a virtual keyboard comprising a first section having a first plurality of virtual keys corresponding to a plurality of alphabetic characters separated by a translatable slider from a second section comprising a second plurality of virtual keys corresponding to a plurality of special characters and, thereafter, manipulating the translatable slider by increasing or decreasing the first section or second section in response to touch input interacting with the virtual keyboard. Any process descriptions or blocks in flow charts should be understood as representing modules, segments, or portions of code which include one or more executable instructions for implementing specific logical functions or steps in the process. Alternate implementations are included, and it will be clear that functions may be executed out of order from that shown or discussed, including substantially concurrently or in reverse order, depending on the functionality involved. Accordingly, the apparatus components and method steps have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

Embodiments of the disclosure do not recite the implementation of any commonplace business method aimed at processing business information, nor do they apply a known business process to the particular technological environment of the Internet. Moreover, embodiments of the disclosure do not create or alter contractual relations using generic computer functions and conventional network operations. Quite to the contrary, embodiments of the disclosure employ methods that, when applied to electronic device and/or user interface technology, improve the functioning of the electronic device itself by and improving the overall user experience to overcome problems specifically arising in the realm of the technology associated with electronic device user interaction.

It will be appreciated that embodiments of the disclosure described herein may be comprised of one or more conventional processors and unique stored program instructions that control the one or more processors to implement, in conjunction with certain non-processor circuits, some, most, or all of the functions of displaying a virtual keyboard comprising a first section comprising a first plurality of virtual keys corresponding to a plurality of alphabetic characters and a second section comprising a second plurality of virtual keys corresponding to a plurality of special characters, as well as automatically moving a slider situated between the first section and the second section to increase or decrease the first section and second section as described herein. The non-processor circuits may include, but are not limited to, a radio receiver, a radio transmitter, signal drivers, clock circuits, power source circuits, and user input devices.

As such, these functions may be interpreted as steps of a method to perform detection of user input interacting with a virtual keyboard comprising a first section comprising a first plurality of virtual keys corresponding to a plurality of alphabetic characters and a second section comprising a second plurality of virtual keys corresponding to a plurality of special characters and automatically translating a translatable slider to adjust area amounts of the first section and the second section in response to the user input. Alternatively, some or all functions could be implemented by a state machine that has no stored program instructions, or in one or more application specific integrated circuits (ASICs), in which each function or some combinations of certain of the functions are implemented as custom logic.

Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ASICs with minimal experimentation.

Embodiments of the disclosure are now described in detail. Referring to the drawings, like numbers indicate like parts throughout the views. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.” Relational terms such as first and second, top and bottom, and the like may be used solely to distinguish one entity or action from another entity or action without necessarily requiring or implying any actual such relationship or order between such entities or actions.

As used herein, components may be “operatively coupled” when information can be sent between such components, even though there may be one or more intermediate or intervening components between, or along the connection path. The terms “substantially,” “essentially,” “approximately,” “about,” or any other version thereof, are defined as being close to as understood by one of ordinary skill in the art, and in one non-limiting embodiment the term is defined to be within ten percent, in another embodiment within five percent, in another embodiment within one percent and in another embodiment within one-half percent. The term “coupled” as used herein is defined as connected, although not necessarily directly and not necessarily mechanically. Also, reference designators shown herein in parenthesis indicate components shown in a figure other than the one in discussion. For example, talking about a device (10) while discussing figure A would refer to an element, 10, shown in figure other than figure A.

Embodiments of the disclosure provide methods and systems for presenting, by one or more processors on a user interface of an electronic device, a virtual keyboard comprising a first section comprising a first plurality of virtual keys corresponding to a plurality of alphabetic characters separated by a translatable slider from a second section comprising a second plurality of virtual keys corresponding to a plurality of special characters. When touch input interacting with the virtual keyboard is received by a touch sensor of the electronic device, the one or more processors can manipulate the translatable slider by moving it within the virtual keyboard. In one or more embodiments, this movement of the translatable slider changes the amount of area occupied by the first section and the second section. Illustrating by example, the one or more processors can manipulate the translatable slider to increase an area occupied by the first section while decreasing another area occupied by the second section. Alternatively, the one or more processors can increase another area of the second section while decreasing the area occupied by the first section.

In one or more embodiments, this manipulation of the translatable slider exposes additional virtual keys corresponding to additional alphabetic characters (when the area occupied by the first section is expanded) or additional virtual keys corresponding to additional special characters (when the second section is expanded). For instance, increasing the area occupied by the first section exposes additional virtual keys corresponding to additional alphabetic characters, while at the same time decreasing the other area occupied by the second section. The decrease in the area occupied by the second section reduces a number of virtual keys corresponding to the special characters from the initial plurality of virtual keys corresponding to the plurality of special characters in one or more embodiments.

Similarly, increasing the other area occupied by the second section exposes additional virtual keys corresponding to additional special characters while at the same time decreasing the area occupied by the first section. The reduction in the first section reduces a number of virtual keys corresponding to the plurality of alphabetic characters from the initial plurality of virtual keys corresponding to the plurality of alphabetic characters in one or more embodiments.

The use of this translatable slider and its adjustment of the first section and the second section lends itself incredibly well to usage in a virtual keyboard when the virtual keyboard is associated with an indigenous language. While virtual keyboards configured in accordance with embodiments of the disclosure work perfectly well for more established languages such as English, German, French, and Chinese, they are remarkably well suited for use with indigenous languages as well. This is true because many indigenous or endangered languages use a more complex blend of alphabetic characters and special characters than, say, English. Accordingly, virtual keyboards configured in accordance with embodiments of the disclosure balance a first section and a second section, using a translatable slider, to balance the unique needs of Nhengatu or Cherokee (as examples) and their rich construction of words using both alphabetic characters and special characters.

Illustrating by example, the applicant of the present application has been named the first electronic device manufacturer to fully support an indigenous language form the Amazon. Embodiments of the present disclosure enable this by supporting, for example, Nheengatu (spoken in the Amazon) and Kaingang (spoken in southern Brazil). Embodiments of the present disclosure allow these languages to be digitized and integrated into smartphones, tablets, and other devices. Embodiments of the disclosure are well suited for other indigenous languages as well, examples of which include American Cherokee. Other indigenous languages that can be supported by virtual keyboards configured in accordance with embodiments of the disclosure will be obvious to those of ordinary skill in the art having the benefit of this disclosure.

In one or more embodiments, an adaptive virtual keyboard has a configurable slider comprising a first section having virtual keyboard associated with alphabetic characters and a second section having virtual keys corresponding to special characters. The virtual keyboard can include tertiary keys and utility keys as well.

In one or more embodiments, each of the first section and the second section is optimized to display the most frequently used alphabetic characters and special characters from the complete set of alphabetic characters and special characters for a given language. While a user can manually manipulate the configurable slider to change the area occupied by the first section and the second section, in other embodiments the configurable slider or translatable slider moves automatically based upon which virtual keys the user has interacted with at a given point in time. In either case, the amount of area occupied by the first section and the second section can be adjusted to reveal or hide alphabetic characters while inversely hiding and revealing special characters, and vice versa.

Using the automatic manipulation of the slider, in one or more embodiments if a user selects and alphabetic character the first section comprising the virtual keys corresponding to the plurality of alphabetic characters gets expanded so long as the user is interacting with the first section substantially continuously. If there is a pause for at least a predefined threshold, in one or more embodiments the translatable slider moves back to the default position of being centered, thereby leaving the first section and the second section having substantially the same area amount. If a user then interacts with a special character virtual key in the second section, the second section can be expanded, revealing additional special character virtual keys, and can remain that way until there is a threshold time gap between virtual key interactions.

In effect, the virtual keyboard assumes that when the user is interacting with the first section or the second section there is some amount of time which is required to switch from interacting with alphabetic characters virtual keys and special characters virtual keys. Illustrating by example, if a user needs to type an email address, such as amit@inventor.zzz, the user may type “amit” very rapidly with each virtual key corresponding to the alphabetic characters spelling “amit” being hit in rapid succession. The user may then pause a moment to find the “@” key, as it is a special character and not an alphanumeric one. When this occurs, the first section showing the plurality of alphabetic characters may reduce in size so that the second section showing the plurality of special characters can expand to reveal the “@” virtual key. After this key is hit, the translatable slider may move automatically again to reveal more alphabetic characters so that “inventor.zzz” can then be typed (.zzz is a fanciful top-level domain used for illustration only). In some embodiments, the amount of time required for there to be no virtual keyboard interaction, and therefore automatic movement of the translatable slider, can be personalized based upon either machine learning from use or from one or more settings in a menu or control panel of the electronic device.

In one or more embodiments, an electronic device comprises a user interface configured to display content and receive touch input from a user. In one or more embodiments, the electronic device has one or more processors operable with the user interface that cause the user interface to display a virtual keyboard. In one or more embodiments, the virtual keyboard comprises a first section comprising a first plurality of virtual keys corresponding to a plurality of alphabetic characters and a second section comprising a second plurality of virtual keys corresponding to a plurality of special characters.

In one or more embodiments, the first section and the second section are separated by a translatable slider that, when manipulated either manually or automatically from input from the user, increases an area occupied by the first section while decreasing another area occupied by the second section, or alternatively increases the other area occupied by the second section while decreasing the area occupied by the first section. In one or more embodiments, the one or more processors return the translatable slider to the midpoint leaving the area occupied by the first section and the other area occupied by second section substantially equal when the input from the user ceases interacting with the virtual keyboard for at least a predefined cessation duration threshold.

In one or more embodiments, when the user pauses for a different amount of time, i.e., an amount of time between a predefined pause duration threshold and the predefined cessation duration threshold, the one or more processors can automatically move the translatable slider to increase the other area occupied by the second section while decreasing the area occupied by the first section. The one or more processors can also cause the user interface to present a third section comprising a third plurality of virtual keys corresponding to numeric characters regardless of where the translatable slider is positioned. The one or more processors can also change the virtual keys corresponding to the special characters when an alternate virtual key associated with the second section is actuated. Examples of this—and other—virtual keyboard function will be described and illustrated in more detail with reference to the figures that follow. Still other potential operation will be obvious to those of ordinary skill in the art having the benefit of this disclosure.

Advantageously, embodiments of the disclosure promote effective and efficient modification of virtual keyboards. This is especially true when the alphabetic characters presented in the first section and the special characters presented in the second section are from a language of an indigenous people, as noted above.

Methods, systems, and devices discussed herein offer many improvements to existing virtual keyboard functionalities. For example, a user is able to directly interact with the virtual keys in either a first section comprising alphabetic character virtual keys or a second section comprising special character virtual keys to move a translatable slider to resize or reshape the first section and the second section. The various versions of the first section and second section can align with the tasks performed by the user.

For instance, if the user wishes to input a sequence of special characters, the user may wish to resize the second section in which the virtual keys corresponding to the special characters are located. By contrast, if inputting a sequence of alphabetic characters, the user may wish to resize the first section in which virtual keys corresponding to alphabetic characters are presented. Advantageously, embodiments of the disclosure can do this automatically based upon user input and context. It should be appreciated that other benefits and efficiencies are envisioned.

Embodiments of the disclosure are compatible with any number of electronic device types, including any combination of hardware and software and supporting various types of input from a user via an interface. For example, the electronic devices suitable for use with embodiments of the disclosure can be a tablet computer, a smart phone, a laptop computer, a personal data assistant (PDA), a remote controller, or other devices.

Further, as used herein, a “virtual keyboard” or “virtual keypad” can be any type of software component that can be displayed on a user interface and on which a user (or other actuating elements such as a stylus) can select alphanumeric characters or symbols. The virtual keyboards can include various types, which have differing amounts, combinations, and layouts of alphanumeric characters and symbols. For example, different types of English alphanumeric keyboards use different layouts such as QWERTY, Dvorak, and Colemak. Also, different types of English alphanumeric keyboards have 101 keys, 60 keys, and 35 keys. Of course, non-English alphabets and the alphabets associated with indigenous peoples result in yet more types of keyboards. Yet another type of virtual keyboard can be a numeric keypad, such as a Bell keyboard or a calculator keyboard. Still further types of keyboards include gaming keyboards, point-of-sale keyboards, and custom keyboards. It should be understood that the terms “virtual keyboard” and “virtual keypad” can be used interchangeably.

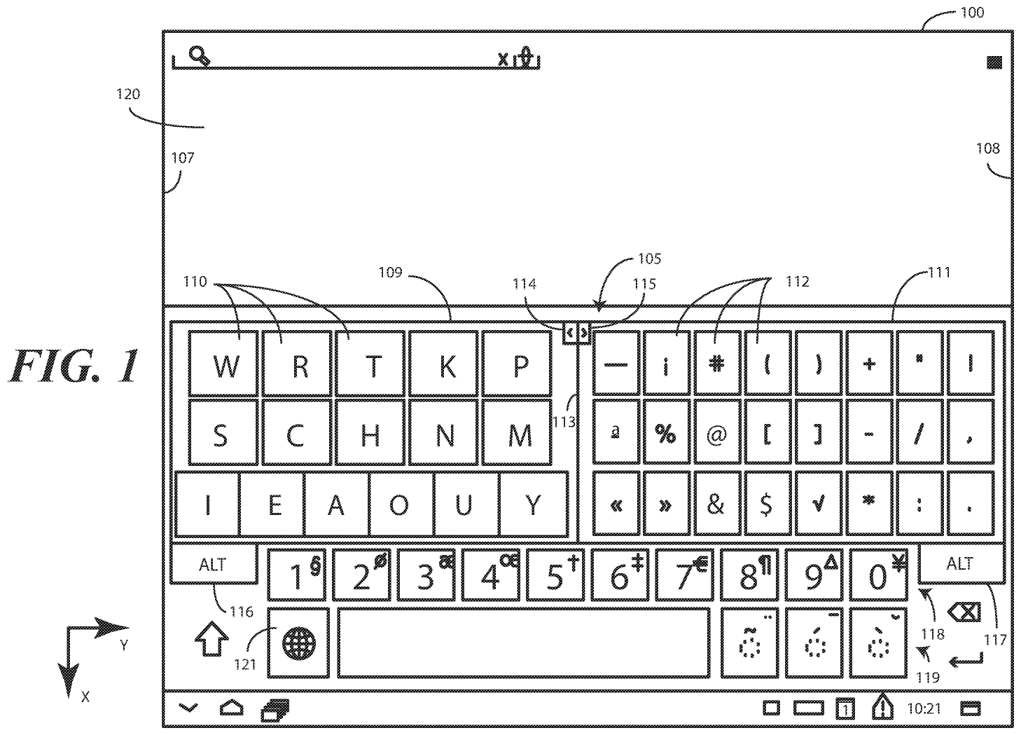

FIGS. 1-6 illustrate exemplary user interfaces of an electronic device consistent with some embodiments. It should be appreciated that user interfaces 100,200,300,400,500 as respectively depicted in FIGS. 1-6 are merely exemplary and can include other various layouts and/or combinations of virtual keys including function keys, alphanumeric characters, special characters, and symbols.

Turning now to FIG. 1, illustrated therein is a user interface 100 that includes a virtual keyboard 105 configured to be displayed on the user interface 100. The virtual keyboard 105 can be implemented by a combination of hardware and software components of an electronic device.

In implementations, the virtual keyboard 105 comprises a first section 109 comprising a first plurality of virtual keys 110 corresponding to a plurality of alphabetic characters and a second section 111 comprising a second plurality of virtual keys 112 corresponding to a plurality of special characters. In the illustrative embodiment of FIG. 1, the first section 109 and the second section 111 are separated by a translatable slider 113.

In one or more embodiments, when a touch sensor of the user interface 100 receives touch input from a finger or stylus interacting with the virtual keyboard 105, one or more processors of the electronic device are operable to manipulate the translatable slider 113. In one or more embodiments, the one or more processors automatically manipulate the translatable slider 113 to one of increase an area occupied by the first section 109 while decreasing another area occupied by the second section 111 or, alternatively, increasing the area occupied by the second section 111 while decreasing the area occupied by the first section 109.

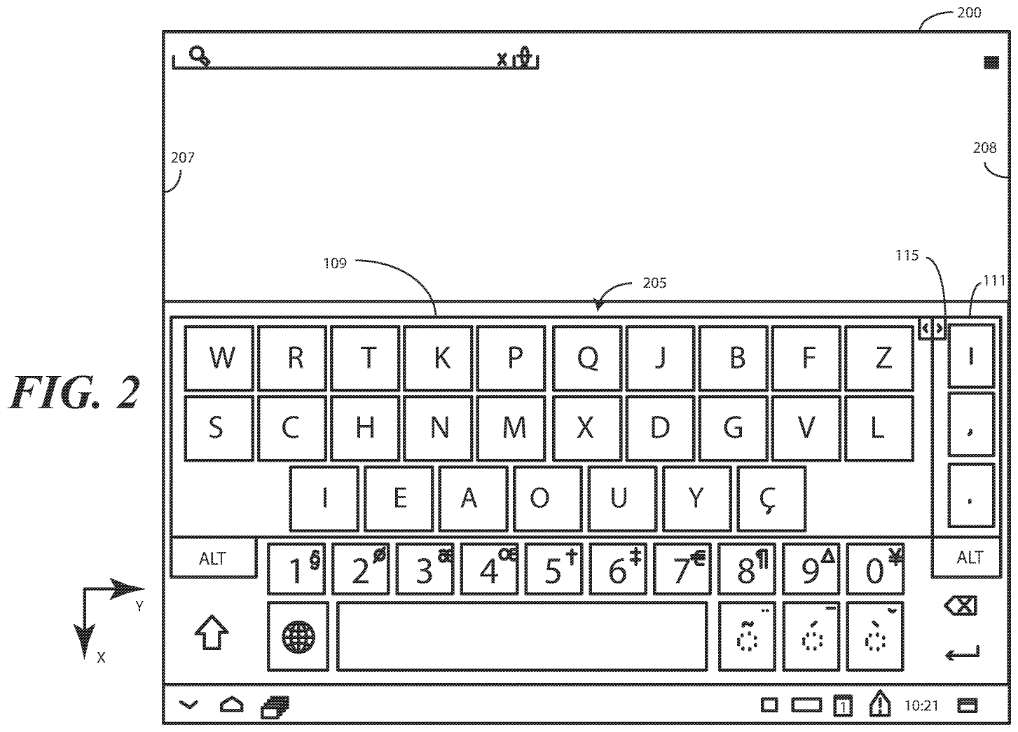

In one or more embodiments, increasing the area occupied by the first section 109 exposes additional virtual keys corresponding to additional alphabetic characters, while decreasing the area occupied by the second section 111 reduces the number of virtual keys corresponding to the special characters in the plurality of virtual keys 112 corresponding to the plurality of special characters. An example of this will be illustrated below with reference to FIG. 2. Similarly, in an exact same but inverse manner, increasing the area occupied by the second section 111 exposes additional virtual keys corresponding to additional special characters, while decreasing the area occupied by the first section 109 reduces the number of virtual keys corresponding to the alphabetic characters in the plurality of virtual keys 110 corresponding to the plurality of alphabetic characters.

In one or more embodiments, when user input interacts with the plurality of virtual keys 110 corresponding to the alphabetic characters in the first section 109, one or more processors of the electronic device manipulate the translatable slider 113 automatically to increase the area occupied by the first section 109 while decreasing the area occupied by the second section 111. Similarly, then user input interacts with the plurality of virtual keys 112 corresponding to the special characters in the second section 111, the one or more processors manipulate the translatable slider 113 to automatically increase the area occupied by the second section 111.

In one or more embodiments, when the one or more processors detect a cessation in the user input interacting with either the first section 109 or the second section 111 exceeding a predefined cessation duration threshold, the one or more processors can automatically return the translatable slider 113 to a default position. In one or more embodiments, the predefined cessation duration threshold is between three hundred and five hundred milliseconds. In one or more embodiments, the default position occurs when the translatable slider 113 is centrally disposed along the virtual keyboard 105 such that the area occupied by the first section 109 and the area occupied by the second section 111 are substantially equal as shown in FIG. 1.

In one or more embodiments, when the one or more processors detect a pause in the user input interacting with either the first section 109 or the second section 111 that exceeds a predefined pause duration threshold that is less that the predefined cessation duration threshold, the one or more processors manipulate the translatable slider 113 to increase the area occupied by the second section 111 while decreasing the area occupied by the first section 109. In one or more embodiments the predefined pause duration threshold is between three and five milliseconds. This can occur, for example, when entering an email address.

In effect, the virtual keyboard 105 assumes that when the user is interacting with the first section 109 or the second section 111 there is some amount of time required to mentally and mechanically switch from interacting with alphabetic characters virtual keys and special characters virtual keys. As noted above, if a user needs to type an email address, such as amit@inventor.zzz, the user may use the plurality of virtual keys 110 corresponding to the plurality of alphabetic characters in the first section 109 to type “amit” very rapidly with each virtual key being hit in rapid succession. The user may then pause a moment to find the “@” key form the plurality of virtual keys 112 corresponding to the plurality of special characters in the second section 111.

In one or more embodiments, when this occurs, the one or more processors can detect a pause in the user input that exceeds the predefined pause duration threshold but that is less than the predefined cessation duration threshold. The one or more processors can then automatically manipulate the translatable slider 113 to increase the area occupied by the second section 111 and decrease the area occupied by the first section 109 so that the “@” key is easily accessible. After this virtual key is hit, the one or more processors may automatically manipulate the translatable slider 113 to again reveal more alphabetic characters so that “inventor.zzz” can then be typed in another rapid succession. In some embodiments, the amount of time required for there to be no virtual keyboard interaction, and therefore automatic movement of the translatable slider, can be personalized based upon either machine learning from use or from one or more settings in a menu or control panel of the electronic device.

As shown in FIG. 1, the virtual keyboard 105 comprises a first alternate virtual key 116 associated with the first section 109 and a second alternate virtual key 117 associated with the second section 111. The first alternate virtual key 116 and second alternate virtual key 117 can work in various ways.

In one or more embodiments, when the touch sensor of the user interface 100 detects additional user input interacting with the first alternate virtual key 116 associated with the first section 109, the one or more processors replace at least some of the virtual keys corresponding to the alphabetic characters in the first plurality of virtual keys 110 with other virtual keys corresponding with other alphabetic characters. In one or more embodiments, when the touch sensor of the user interface 100 detect additional user input interacting with the second alternate virtual key 117 associated with the second section 111, the one or more processors automatically replace at least some of the virtual keys corresponding to the special characters in the second plurality of virtual keys 112 with other virtual keys corresponding to other special characters.

In other embodiments, when the touch sensor of the user interface 100 detects additional user input interacting with the first alternate virtual key 116 associated with the first section 109, the one or more processors cause the first section 109 to expand, thereby revealing additional virtual keys corresponding to additional alphabetic characters. In one or more embodiments, when the touch sensor of the user interface 100 detect additional user input interacting with the second alternate virtual key 117 associated with the second section 111, the one or more processors cause the second section 111 to expand, thereby revealing additional virtual keys corresponding to additional special characters.

In still other embodiments, a combination of replacement and reveal can be used. Illustrating by example, when the touch sensor of the user interface 100 detects additional user input interacting with the first alternate virtual key 116 associated with the first section 109, the one or more processors can cause the first section 109 to expand, thereby revealing additional virtual keys corresponding to additional alphabetic characters while at the same time replacing some or all of the initially presented virtual keys corresponding to the alphabetic characters in the first plurality of virtual keys 110 with other virtual keys corresponding with other alphabetic characters. In one or more embodiments, when the touch sensor of the user interface 100 detect additional user input interacting with the second alternate virtual key 117 associated with the second section 111, the one or more processors can cause the second section 111 to expand, thereby revealing additional virtual keys corresponding to additional special characters, while at the same time replacing some or all of the initially presented virtual keys corresponding to the special characters in the second plurality of virtual keys 112 with other virtual keys corresponding to other special characters.

In one or more embodiments, the virtual keyboard 105 further comprises a third section 118 depicting a third plurality of virtual keys corresponding to a plurality of numeric characters. In one or more embodiments, the third section remains unchanged regardless of where the translatable slider 113 is positioned. As shown in FIG. 1, each virtual key in the third section 118 has a number and a special character situated in a superscript position above and to the right of the number with which it is associated. In one or more embodiments, a “long press” of these virtual keys causes the special character to be populated in the content field 120, while a short press populates the numeric character.

Similarly, in one or more embodiments the virtual keyboard 105 further comprises a fourth section 119 comprising a fourth plurality of virtual keys dedicated to one or both of accents or accent characters. These accents or accent characters can change based upon the language to which the virtual keyboard 105 is intended. As noted above, the virtual keyboard 105 of FIG. 1 works incredibly well with endangered and indigenous languages, one example of which is Nheengatu from Latin America. The accents and accent characters associated with Nheengatu will, of course, be different from the accents and accent characters associated with, say, French. Accordingly, the accent characters found in the fourth section 119 will vary from language to language.

In this illustrative embodiment, the fourth section 119 comprises three dedicated virtual keys that are only used for accents. However, in this illustrative embodiment a long press reveals another accent shown in superscript above and to the right of the primary accent. Moreover, in one or more embodiments the virtual keys in the fourth section 119 can have a shift function associated therewith that provides additional accents, both primary and secondary. Accordingly, a total of twelve accents can be provided using three dedicated virtual keys in the fourth section 119 when they have an associated shift function.

In one or more embodiments, the translatable slider 113 is manually adjustable using a pair of directional virtual keys 114,115. In one or more embodiments, when the touch sensor detects additional user input interacting with the directional virtual keys 114,115 for the translatable slider 113, the one or more processors move the translatable slider 113 in a direction corresponding to the directional virtual keys 114,115 with which the user input interacted. Illustrating by example, if directional virtual key 114 is touched, the translatable slider 113 moves left to reveal more special characters virtual keys. Similarly, when directional virtual key 115 is touched, the translatable slider 113 moves right to reveal additional alphabetic characters virtual keys.

As shown in the first section 109, when the translatable slider 113 is in the default position the plurality of virtual keys 110 corresponding to the plurality of alphabetic characters is less than the total number of virtual keys and alphabetic characters. In one or more embodiments, the plurality of virtual keys 110 that are provided correspond to the most likely alphabetic characters that are to be used at a given point in time. When a user interacts with the plurality of virtual keys 110, the alphabetic characters can change as the probability of their being selected changes.

However, if a user needs a virtual key corresponding to a particular alphabetic character that is not shown, for example, when the translatable slider 113 is in the default position, the user may take one of two actions to reveal more virtual keys corresponding to more alphabetic characters. First, the user may simply tap the directional virtual key 115 to cause the first section 109 to expand, thereby revealing additional virtual keys corresponding to additional alphabetic characters. Alternatively, the user can touch the first alternate virtual key 116 to cause the virtual keys 110 being presented to be associated with different alphabetic characters.

The second section 111 can work in a similar fashion. When the translatable slider 113 is in the default position the plurality of virtual keys 112 corresponding to the plurality of special characters is less than the total number of virtual keys and special characters that are available. In one or more embodiments, the plurality of virtual keys 112 that are provided correspond to the most likely special characters that are to be used at a given point in time. When a user interacts with the plurality of virtual keys 112, the special characters can change as the probability of their being selected changes.

However, if a user needs a virtual key corresponding to a particular special character that is not shown, for example, when the translatable slider 113 is in the default position, the user may take one of two actions to reveal more virtual keys corresponding to more alphabetic characters. First, the user may simply tap the directional virtual key 114 to cause the second section 111 to expand, thereby revealing additional virtual keys corresponding to additional special characters. Alternatively, the user can touch the second alternate virtual key 117 to cause the virtual keys 112 being presented to be associated with different special characters.

Accordingly, in one or more embodiments the first section 109 and second section 111 expand and diminish in accordance with a number of alphabetic characters or special characters that are probabilistically selected as likely to be used. However, by using the directional virtual keys 114,115 and alternate virtual keys 116,117, a user has complete control to access any and all alphabetic characters and special characters as needed when creating content.

Thus, as illustrated and described, the virtual keyboard 105 of FIG. 1 includes a translatable slider 113 that functions as a configurable slider to separate a first section 109 comprising a plurality of virtual keys 110 corresponding to a plurality of alphabetic characters from a second section 111 comprising another plurality of virtual keys 112 corresponding to a plurality of special characters. A third section 118 provides a dedicated set of virtual keys corresponding to numeric characters, while a fourth section 119 provides a dedicated set of virtual keys corresponding to accents and accent characters.

In one or more embodiments, the plurality of virtual keys 110 corresponding to the plurality of alphabetic characters and the plurality of virtual keys 112 corresponding to the plurality of special characters are optimized such that the alphabetic characters and special characters presented represent the most frequently used alphabetic characters and spec from the complete set of alphabetic characters and special characters for a given context of content creation within a given language. To reveal additional alphabetic characters or special characters, a user can manipulate the translatable slider 113 manually using a pair of directional virtual keys 114,115 and/or a pair of alternate virtual keys 116,117. The pair of directional virtual keys 114,115 can operate in response to a “tap” where they cause a corresponding section to open by a predetermined amount. Alternatively, the pair of directional virtual keys 114,115 can be used in response to a “touch and drag” where a user can move the translatable slider 113 as much as desired by dragging it across the user interface 100. The amount of area revealed in response to the pair of alternate virtual keys 116, 117 (if any) is user configurable in one or more embodiments.

In other embodiments, manipulation of the translatable slider 113 occurs automatically. Illustrating by example, if a user selects a virtual key corresponding to an alphabetic character, in one or more embodiments one or more processors of the electronic device automatically manipulate the translatable slider 113 to expand the first section 109, thereby revealing more virtual keys corresponding to more alphabetic characters, while simultaneously reducing the area occupied by the second section 111 and the corresponding plurality of virtual keys 112 corresponding to the plurality of special characters.

In one or more embodiments, as soon as a threshold time elapses from the last virtual key interaction with an alphabetic character, the one or more processors can again manipulate the translatable slider 113 back to a default setting where the translatable slider 113 is generally centrally disposed (as shown in FIG. 1) with the area occupied by the first section 109 and the area occupied by the second section 111 being substantially equal.

In a similar fashion, if a user interacts with a virtual key corresponding to a special character, the one or more processors can manipulate the translatable slider 113 to cause the second section 111 to expand, thereby revealing additional virtual keys corresponding to additional special characters while reducing the area occupied by the first section 109 and hiding at least some of the plurality of virtual keys 110 corresponding to the plurality of alphabetic characters. This can continue until there is a pause of interaction with the virtual keys corresponding to the special characters, when the one or more processors cause the translatable slider 113 to return to the default position.

In one or more embodiments, this automatic manipulation of the translatable slider 113 occurs based upon the logic that while a user is typing there is some amount of time require to switch from interacting with virtual keys corresponding to alphabetic characters to other virtual keys corresponding to special characters. Again using the entry of an email address as an easy-to-understand example, if a person needs to type “buster.mac@ptnagnt.zzz,” the user would likely type “buster” in fast succession, pausing a few milliseconds to find the “.” special character and then typing “mac” in another fast succession of virtual key interactions. The user would again pause for a few milliseconds to find the “@” special character virtual key, and so forth. By automatically manipulating the translatable slider 113 during these pauses, the user is able to more quickly find and interact with the virtual key he desires while keeping the virtual keyboard 105 small and compact enough to use on a smartphone or other compact electronic device.

In still other embodiments, the threshold time to consider when to manipulate the translatable slider 113 can be personalized. Illustrating by example, a user can set the duration thresholds for translatable slider manipulation in a menu of settings or a control panel. Alternatively, the one or more processors can use machine learning or artificial intelligence to learn the particular typing cadence of an individual user, thereafter defining predefined cessation duration thresholds and predefined pause duration thresholds that are specifically configured for a user's typing style.

In one or more embodiments, the virtual keyboard 105 includes other standard virtual keys found on many conventional virtual keyboards, including a delete key and a carriage return. In one or more embodiments, the virtual keyboard 105 also includes a keyboard change key 121. In one or more embodiments, if no other keyboard is in use, the keyboard change key 121 can be used as an emoji selection key. Other standard virtual keys that can be included with the virtual keyboard 105 will be obvious to those of ordinary skill in the art having the benefit of this disclosure. Additionally, while the virtual keyboard 105 of FIG. 1 is shown in the landscape orientation where the virtual keyboard 105 extends to opposite narrower sides 107, 108 of the user interface 100, it can be presented in a portrait orientation as well.

User interactions with virtual keys of the virtual keyboard 105 can be inputs into various applications or functions executing on the electronic device and/or displaying on the user interface 100. Further, in implementations, the virtual keys of the first section 109 and the second section 111 can be configured with particular layouts. Illustrating by example, the plurality of virtual keys 110 corresponding to the plurality of alphabetic characters can be configured as a “QWERTY” keyboard (or other type of keyboard) including various amounts of keys (e.g., 41, 101, or other amounts) or other types and arrangements of keyboard layouts.

Now that the basic operation of the virtual keyboard 105 is understood, FIGS. 2-5 illustrate various use cases that serve to further illustrate the virtual keyboard 105 in action. Beginning with FIG. 2, once again a user interface 200 includes a virtual keyboard 205 configured to be displayed on the user interface 200. The virtual keyboard 205 can be implemented by a combination of hardware and software components of the electronic device. Further, the virtual keyboard 205 can have the same or similar components and functionalities as discussed with respect to the virtual keyboard (105) of FIG. 1. In the illustrative embodiment of FIG. 2, the virtual keyboard 205 is displayed in a portrait orientation of the user interface 200 with the sides of the virtual keyboard 205 can extend to opposite narrower sides 207,208 of the user interface 200. However, the virtual keyboard 205 can be displayed in portrait orientation as well.

In this use case the virtual keyboard (105) of FIG. 1 has transformed to the virtual keyboard 205 of FIG. 2 by becoming a “100% alphabetic characters” virtual keyboard. Specifically, the translatable slider 113 has moved to the right to expand the first section 109 and reveal more virtual keys corresponding to more alphabetic characters. This expansion of the first section 109 has caused a contraction of the second section 111, thereby reducing the number of virtual keys corresponding to special characters. In this illustrative embodiment, all alphabetic characters are now available in the first section 109.

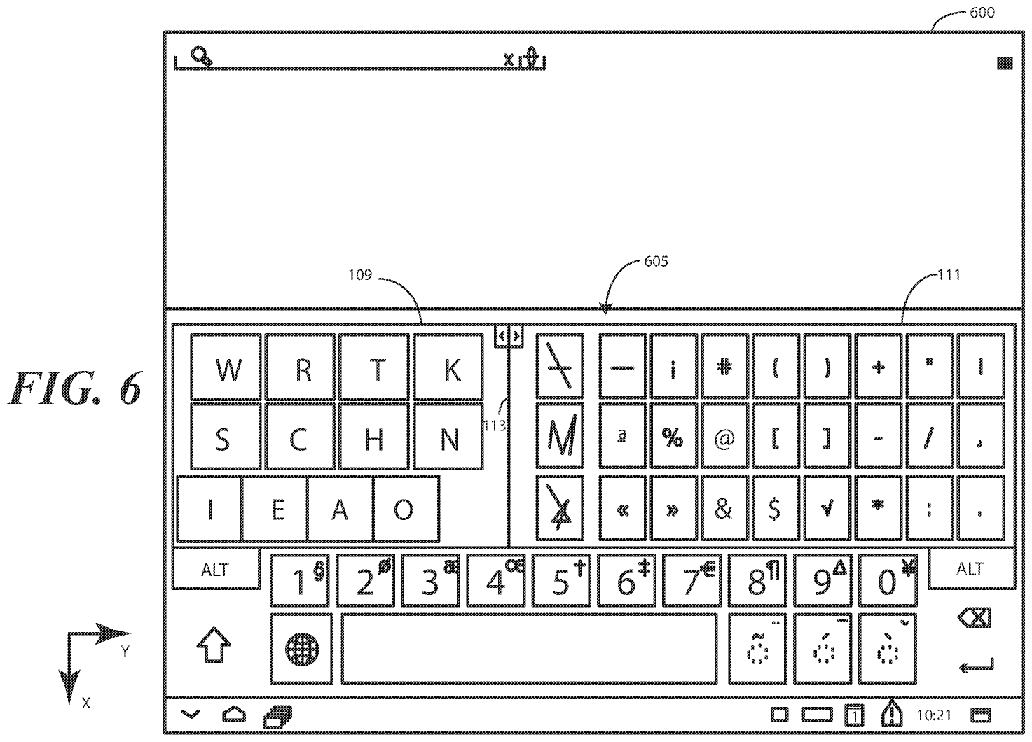

As noted above, this manipulation of the translatable slider 113 can occur in a variety of ways. A user could have touched directional virtual key 115 to cause the first section 109 to expand. The user may have dragged the directional virtual key 115 in other configurations. Alternatively, the one or more processors may have caused the translatable slider 113 to move in response to a user interacting with the virtual keys originally presented in the first section 109 when the translatable slider 113 was in the default position. Other reasons for moving the translatable slider 113 will be obvious to those of ordinary skill in the art having the benefit of this disclosure. Additionally, while the action shown in FIG. 2 was expanding the first section 109 to reveal additional virtual keys corresponding to additional alphabetic characters, the same, but opposite, operation could have been performed on the second section 111 as shown in FIG. 6, where the user interface 600 presents a virtual keyboard 605 where the translatable slider 113 has moved to the left, thereby expanding the area occupied by the second section 111 and contracting the area occupied by the first section 109.

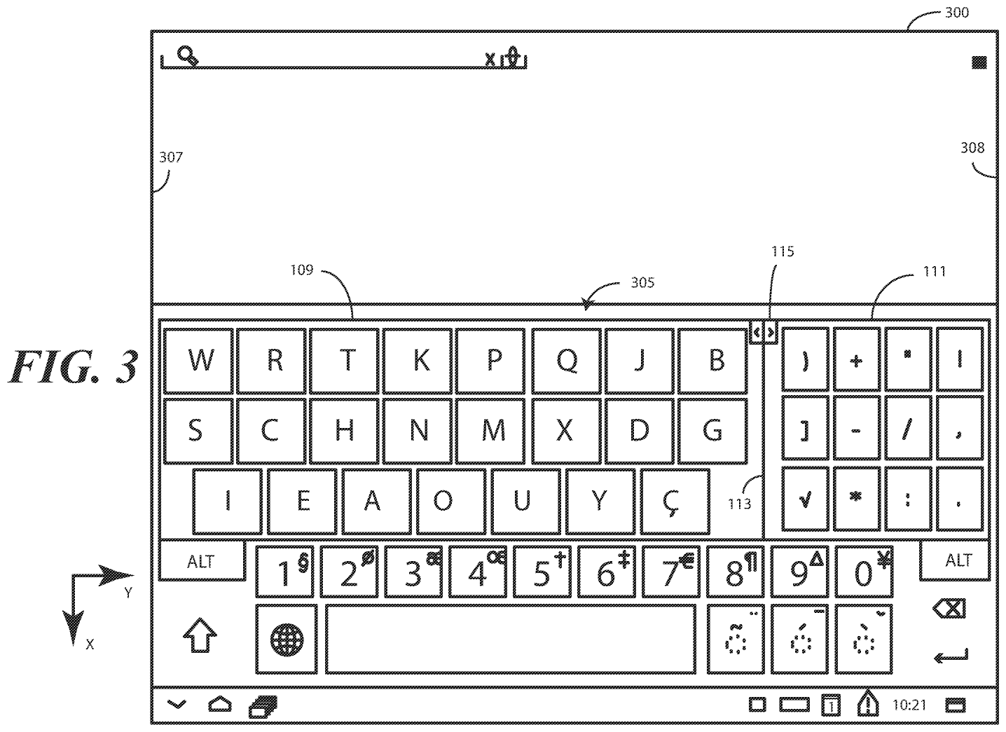

While exposing all alphabetic characters in response to manipulating the translatable slider 113 is one possible use case, embodiments of the disclosure are not so limited. Embodiments of the disclosure contemplate that the amount of translation of the translatable slider 113 that occurs—either automatically or in response to user input—can be user defined. Accordingly, turning now to FIG. 3, illustrated therein is another use case where a smaller manipulation of the translatable slider 113 occurs.

Once again a user interface 300 includes a virtual keyboard 305 configured to be displayed on the user interface 300. The virtual keyboard 305 can be implemented by a combination of hardware and software components of the electronic device. Further, the virtual keyboard 305 can have the same or similar components and functionalities as discussed with respect to the virtual keyboard (105) of FIG. 1 and/or the virtual keyboard (205) of FIG. 2.

In the illustrative embodiment of FIG. 3, the virtual keyboard 305 is displayed in a portrait orientation of the user interface 300 with the sides of the virtual keyboard 305 can extend to opposite narrower sides 307,308 of the user interface 300. However, the virtual keyboard 305 can be displayed in portrait orientation as well.

In this use case the virtual keyboard (105) of FIG. 1 has transformed to the virtual keyboard 305 of FIG. 3 by becoming only a “75% alphabetic characters” virtual keyboard. Specifically, the translatable slider 113 has moved to the right to expand the first section 109 and reveal more virtual keys corresponding to more alphabetic characters. This expansion of the first section 109 has caused a contraction of the second section 111, thereby reducing the number of virtual keys corresponding to special characters.

However rather than making all alphabetic characters available in the first section 109, the virtual keyboard 305 of FIG. 3 makes most, but not all, alphabetic characters accessible. Advantageously, this leaves a larger area occupied by the second section 111, which means that more special characters are visible on the virtual keyboard 305.

While not all alphabetic characters are shown, it is childlike in its simplicity for a user to find the remaining virtual keys corresponding to the remaining alphabetic characters. Similarly, while not all special characters are shown, it is equally as simple to reveal the remaining special characters. Both can be accomplished by using the first alternate virtual key 116 and second alternate virtual key 117, respectively.

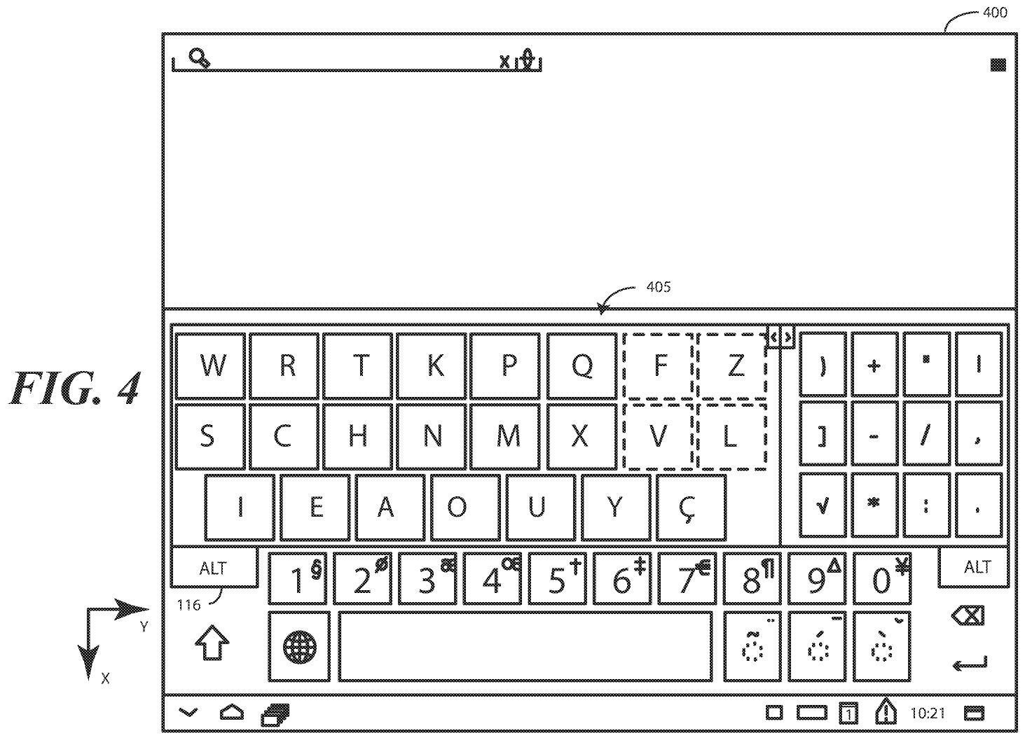

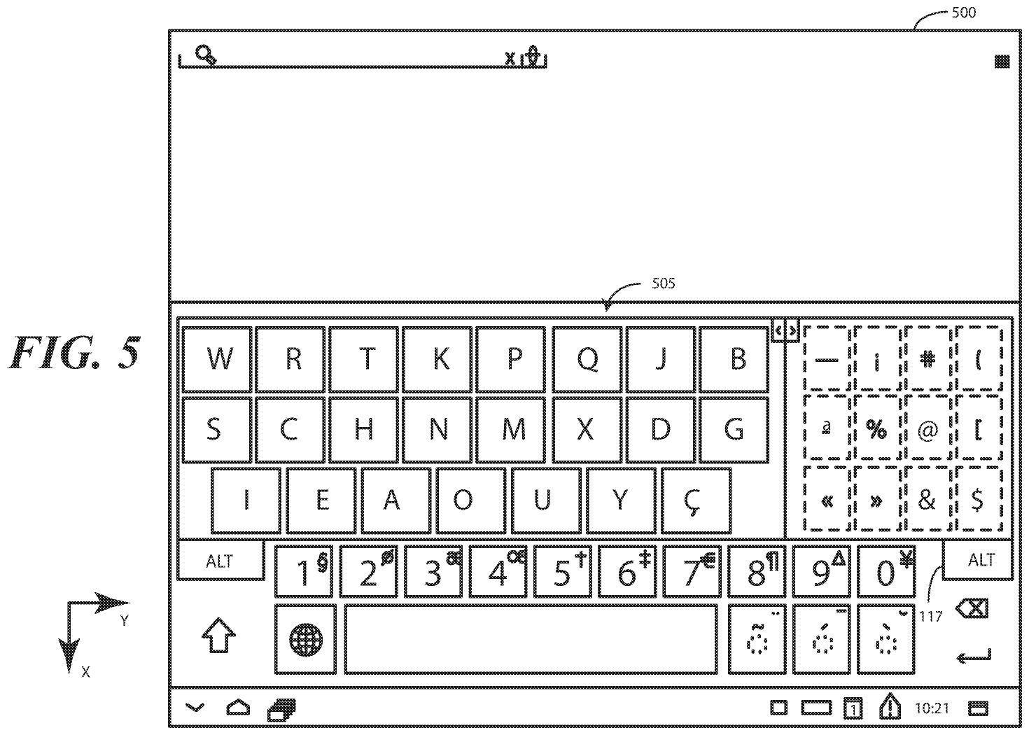

Illustrating by example, turning briefly to FIG. 4, in this virtual keyboard 405 a user has delivered touch input to the first alternate virtual key 116. This causes the upper four characters, which were previously “J,” “B,” “D,” and “G,” to transition to “alternate” alphabetic characters, namely, “F,” “Z,” V,” and “L.” Similarly, turning briefly to FIG. 5, in this virtual keyboard 505 the user has delivered touch input to the second alternate virtual key 117. As shown, the special characters of FIG. 3 have been replaced with a completely different set of special characters. This is the magic of the alternate virtual keys.

Turning now back to FIG. 3, the manipulation of the translatable slider 113 can occur in a variety of ways. A user could have touched directional virtual key 115 to cause the first section 109 to expand. The user may have dragged the directional virtual key 115 in other configurations. Alternatively, the one or more processors may have caused the translatable slider 113 to move in response to a user interacting with the virtual keys originally presented in the first section 109 when the translatable slider 113 was in the default position. Other reasons for moving the translatable slider 113 will be obvious to those of ordinary skill in the art having the benefit of this disclosure. Additionally, while the action shown in FIG. 3 was expanding the first section 109 to reveal additional virtual keys corresponding to additional alphabetic characters, the same, but opposite, operation could have been performed on the second section 111 as shown in FIG. 6, where the user interface 600 presents a virtual keyboard 605 where the translatable slider 113 has moved to the left, thereby expanding the area occupied by the second section 111 and contracting the area occupied by the first section 109.

Thus, as shown in FIGS. 1-6, a method in an electronic device comprises detecting, with a user interface (100,200,300), user input interacting with a virtual keyboard (105,205,305,405,505) comprising a first section 109 comprising a first plurality of virtual keys 110 corresponding to a plurality of alphabetic characters separated by a translatable slider 113 from a second section 111 comprising a second plurality of virtual keys 112 corresponding to a plurality of special characters. Thereafter, one or more processors can automatically cause the translatable slider 113 to translate to either increase an area occupied by the first section 109 while decreasing another area occupied by the second section 111 or, alternatively, increase the area occupied by the second section 111 while decreasing the area occupied by the first section 109.

As shown in these figures, in one or more embodiments the translatable slider 113 is oriented vertically between the first section 109 and the second section 111. Thus, the one or more processors can move the translatable slider 113 horizontally across the virtual keyboard to change the area occupied by the first section 109 and second section 111, respectively.

Since the alphabetic characters and special characters presented in each of the first section 109 and second section 111 are selected as being the most likely to be needed, in one or more embodiments the one or more processors select the plurality of virtual keys 110 corresponding to the plurality of alphabetic characters and the plurality of virtual keys 112 corresponding to the plurality of special characters as a function of past interactions with those same keys in the first section 109 or second section 111, and so forth.

Additionally, the alphabetic characters and special characters selected for presentation at any one given time can be a function of the active software application as well. Alternatively, upon launch of a software application, the software application may provide an option for a user to select a particular type of initial virtual keyboard. After the user selects the initial type of virtual keyboard, the user may resize the first section 109 and second section 111 of the virtual keyboard by manually manipulating the translatable slider 113. In the process of resizing the first section 109 and second section 111 of the virtual keyboard, the alphabetic characters and special characters presented in the virtual keyboard may change from the initial type to a different type as illustrated.

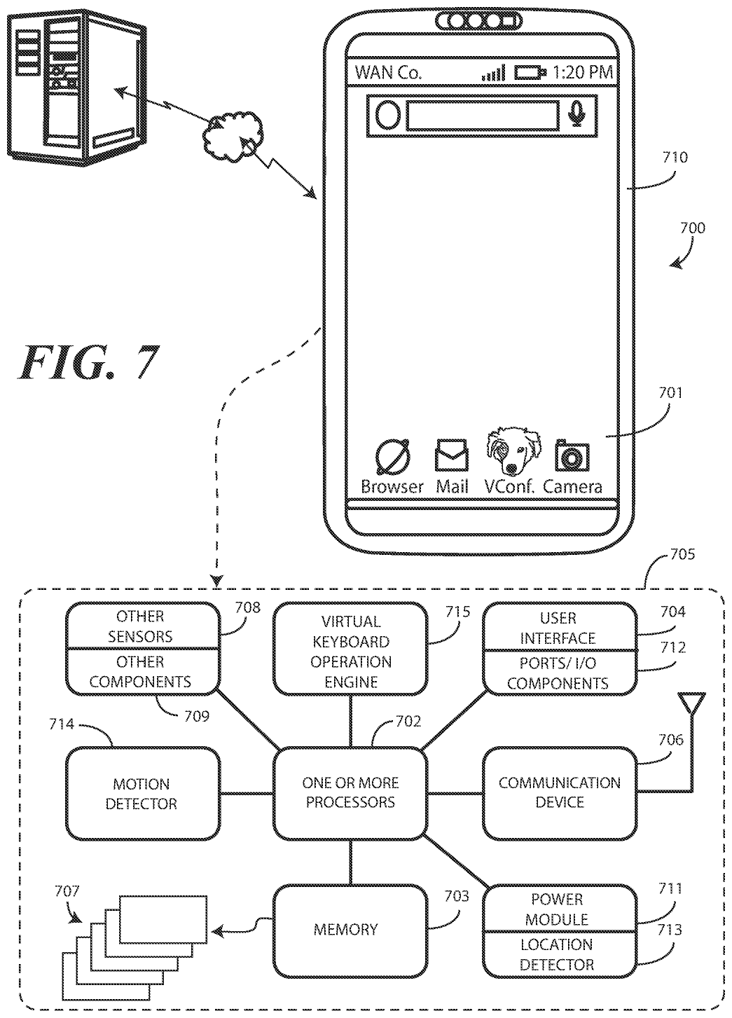

Turning now to FIG. 7, illustrated therein is one explanatory electronic device 700 in which the methods and systems described herein may be implemented in accordance with one or more embodiments. The electronic device 700 of FIG. 7 is a portable electronic device. For illustrative purposes, the electronic device 700 is shown as a smartphone. However, the electronic device 700 could be any number of other devices as well, including tablet computers, desktop computers, notebook computers, and so forth. Still other types of conferencing system terminal devices can be configured in accordance with one or more embodiments of the disclosure as will be readily appreciated by those of ordinary skill in the art having the benefit of this disclosure.

This illustrative electronic device 700 includes a display 701, which may optionally be touch sensitive. In one embodiment where the display 701 is touch-sensitive, the display 701 can serve as a primary user interface 704 of the electronic device 700. Users can deliver user input to the display 701 of such an embodiment by delivering touch input from a finger, stylus, or other objects disposed proximately with the display 701.

In one embodiment, the display 701 is configured as an active-matrix organic light emitting diode (AMOLED) display. However, it should be noted that other types of displays, including liquid crystal displays, would be obvious to those of ordinary skill in the art having the benefit of this disclosure.

In one or more embodiments, the electronic device 700 includes a device housing 710. The device housing 710 can include one or more housing portions, such as a first housing portion and a second housing portion. In this illustrative embodiment, the device housing 710 is disposed about the periphery of a display 701, thereby defining a major face of the electronic device 700.

In one or more embodiments, the device housing 710 is manufactured from a rigid material such as a rigid thermoplastic, metal, or composite material, although other materials can be used as well. Still other constructs will be obvious to those of ordinary skill in the art having the benefit of this disclosure. While the illustrative electronic device 700 of FIG. 7 includes a single device housing 710, in other embodiments a first device housing can be coupled to a second device housing by a hinge such that the first device housing is pivotable about the hinge relative to the second device housing between an axially displaced open position and a closed position like a clamshell.

In other embodiments, the electronic device 700 will be bendable, but will not include a hinge. Illustrating by example, the device housing 710 can be manufactured from bendable materials.

In still other embodiments, the electronic device 700 can be bendable via a combination of hinge components and non-hinge components. Illustrating by example, in another embodiment the electronic device 700 of FIG. 7 includes a single, flexible device housing. In one embodiment, the device housing 710 may be manufactured from a malleable, bendable, or physically deformable material such as a flexible thermoplastic, flexible composite material, flexible fiber material, flexible metal, organic or inorganic textile or polymer material, or other materials. The device housing 710 could be formed from a single flexible housing member or from multiple flexible housing members. In other embodiments, the device housing 710 could be a composite of multiple components. For instance, in another embodiment the device housing 710 could be a combination of rigid segments connected by hinges or flexible materials. Still other constructs will be obvious to those of ordinary skill in the art having the benefit of this disclosure.

A block diagram schematic 705 of the electronic device 700 is also shown in FIG. 7. The block diagram schematic 705 can be configured as a printed circuit board assembly disposed within the device housing of the electronic device 700. Various components can be electrically coupled together by conductors, or a bus disposed along one or more printed circuit boards.

In one or more embodiments, the electronic device 700 includes one or more processors 702. In one embodiment, the one or more processors 702 can include an application processor and, optionally, one or more auxiliary processors. One or both of the application processor or the auxiliary processor(s) can include one or more processors. One or both of the application processor or the auxiliary processor(s) can be a microprocessor, a group of processing components, one or more ASICs, programmable logic, or other type of processing device.

The application processor and the auxiliary processor(s) can be operable with the various components of the electronic device 700. Each of the application processor and the auxiliary processor(s) can be configured to process and execute executable software code to perform the various functions of the electronic device 700. A storage device, such as memory 703, can optionally store the executable software code used by the one or more processors 702 during operation.

The electronic device 700 also includes a communication device 706 that can be configured for wired or wireless communication with one or more other devices or networks. The networks can include a wide area network, a local area network, and/or personal area network. The communication device 706 may also utilize wireless technology for communication, such as, but are not limited to, peer-to-peer or ad hoc communications such as HomeRF, Bluetooth and IEEE 802.11, and other forms of wireless communication such as infrared technology. The communication device 706 can include wireless communication circuitry, one of a receiver, a transmitter, or transceiver, and one or more antennas.

In one embodiment, the one or more processors 702 can be responsible for performing the primary functions of the electronic device 700. For example, in one embodiment the one or more processors 702 comprise one or more circuits operable with one or more user interface devices, which can include the display 701, to engage in electronic communication with other electronic devices by transmitting, receiving, and presenting images, video, or other presentation information. The executable software code used by the one or more processors 702 can be configured as one or more modules 707 that are operable with the one or more processors 702. Such modules 707 can store instructions, control algorithms, logic steps, and so forth.

In one embodiment, the one or more processors 702 are responsible for running the operating system environment of the electronic device 700. The operating system environment can include a kernel and one or more drivers, and an application service layer, and an application layer. The operating system environment can be configured as executable code operating on one or more processors or control circuits of the electronic device 700. The application layer can be responsible for executing application service modules. The application service modules may support one or more applications or “apps.” The applications of the application layer can be configured as clients of the application service layer to communicate with services through application program interfaces (APIs), messages, events, or other inter-process communication interfaces. Where auxiliary processors are used, they can be used to execute input/output functions, actuate user feedback devices, and so forth.

In one embodiment, the one or more processors 702 may generate commands or execute control operations based upon user input received at the user interface 704. Moreover, the one or more processors 702 may process the received information alone or in combination with other data, such as the information stored in the memory 703.

The electronic device 700 can include one or more sensors 708. The one or more sensors 708 may include a microphone, an earpiece speaker, and/or a second loudspeaker. The one or more other sensors 708 may also include touch actuator selection sensors, proximity sensors, a touch pad sensor, a touch screen sensor, a capacitive touch sensor, and one or more switches. Touch sensors may be used to indicate whether any of the user actuation targets present on the display 701, including the audio difficulties user actuation targets described above, are being actuated. The other sensors 708 can also include audio sensors and video sensors (such as a camera).

Other components 709 operable with the one or more processors 702 can include output components such as video outputs, audio outputs, and/or mechanical outputs. Examples of output components include audio outputs such as speaker port, earpiece speaker, or other alarms and/or buzzers and/or a mechanical output component such as vibrating or motion-based mechanisms. Still other components will be obvious to those of ordinary skill in the art having the benefit of this disclosure.

The other components 709 can also include an audio input/processor. The audio input/processor can include hardware, executable code, and speech monitor executable code in one embodiment. The audio input/processor can include, stored in memory 703, basic speech models, trained speech models, or other modules that are used by the audio input/processor to receive and identify voice commands that are received with audio input captured by an audio input/processor, one example of which is a microphone of the one or more sensors 708. In one embodiment, the audio input/processor can include a voice recognition engine. Regardless of the specific implementation utilized in the various embodiments, the audio input/processor can access various speech models to identify speech commands in one or more embodiments.

The memory 703 can include one or more memory devices, examples of which include flash memory, hard drives, MicroSD cards, and others. A power module 711 can provide power for the electronic device 700, and can include batteries, charging circuits, and other components). The electronic device can include one or more ports as I/O components 712, examples of which include Universal Serial Bus (USB) ports, Firewire ports, HDMI ports, GPS ports, cellular ports, and others.

A location detector 713 can determine location of the electronic device 700, while a motion detector 714 can determine motion of the electronic device 700 and a geometric orientation of the electronic device 700 in three-dimensional space.

A virtual keyboard operation engine 715 can present virtual keyboards in accordance with embodiments of the disclosure on the display 701. Illustrating by example, in one or more embodiments the user interface 704 is configured to display content and receive input from a user via a touch sensor. In one or more embodiments, the one or more processors 702 cause the user interface 704 to display a virtual keyboard comprising a first section comprising a first plurality of virtual keys corresponding to a plurality of alphabetic characters and a second plurality of virtual keys corresponding to a plurality of special characters, as previously described. In one or more embodiments, the first section and the second section are separated by a translatable slider that, when manipulated by input from a user or automatically by the one or more processors 702, increases an area occupied by the first section while decreasing another area occupied by the second section, or increases the area occupied by the second section while decreasing the area occupied by the first section.

In one or more embodiments, the virtual keyboard operation engine 715, which can be a component of the one or more processors 702, operable with the one or more processors 702, a hardware component operable with the one or more processors 702, or integrated into the one or more processors 702, can automatically move the translatable slider as well. This can increase the abo the first section while decreasing the area occupied by the second section when input from the user interacts with virtual keys of the first plurality of virtual keys. Alternatively, this can increase the area occupied by the second section while decreasing the abo the first section when the input from the user interacts with the virtual keys of the second plurality of virtual keys.

In one or more embodiments, the virtual keyboard operation engine 715 can return the translatable slider to a midpoint which leaves the area occupied by the first section and the other area occupied by the second section substantially equal when the input from the user ceases interacting with the virtual keyboard for at least a predefined cessation duration threshold. The virtual keyboard operation engine 715 can automatically move the translatable slider to increase the area occupied by the second section while decreasing the area occupied by the first section when the input from the user pauses for a duration between a predefined pause duration threshold and the predefined cessation duration threshold. The virtual keyboard operation engine 715 can also present a third section comprising a third plurality of virtual keys corresponding to numeric characters regardless of where the translatable slider is positioned. Alternate virtual keys associated with the first section and the second section can change the virtual keys of the first section and second section, respectively, when input from a user interacts with these alternate virtual keys. In any given embodiment, more, fewer, or different ones of such electronic components may be present in the electronic device 700.

In one or more embodiments, the display 701 can be a touchscreen display configured to interact with various manipulators, such as a human finger or a stylus. Each type of manipulator, when brought into contact with or close proximity to the display 701, can cause the display 701 (and/or a display driver associated with the display 701 to produce a signal that can be received and interpreted as a touch event by the one or more processors 702. The one or more processors 702 and/or virtual keyboard operation engine 715 can be suitably configured, through any combination of hardware and software components, to determine the location of the contact on the surface of the display 701, as well as other selected attributes of the touch event (e.g., movement of the manipulator(s) across the surface of the screen, directions and velocities of such movement, touch pressure, touch duration, and others).

In an embodiment in which the display 701 is a touchscreen display, the display 701 can include a thin, transparent touch sensor component superimposed upon a display (e.g., a Liquid Crystal Display (LCD) or other type of display) that is viewable by a user. Examples of such displays include capacitive displays, resistive displays, surface acoustic wave (SAW) displays, optical imaging displays, and the like. The display 701 or one of the additional I/O components 712 may also provide haptic feedback to the user (e.g., a clicking response or keypress feel) in response to a touch event. Embodiments contemplate any suitable touch sensitive surface or sensor. In alternate embodiments, the display 701 can be replaced with a display screen that does not include a touch sensitive surface or sensor, and a user can select locations on the display screen by moving a displayed cursor to such locations using a cursor control device (e.g., a mouse, a touchpad, or a trackball) or another type of user input, and selecting the locations (e.g., with a cursor click).

The display 701 can have any suitable rectilinear or curvilinear shape and may be oriented in any desired fashion. The illustrated embodiments, without loss of generality, depict rectangular regions oriented in a portrait or landscape orientation (i.e., with respect to a user holding the device). However, embodiments of the disclosure comprehend any range of shapes, sizes, and orientations for the display 701.

In general, a computer program product in accordance with an embodiment includes a computer usable storage medium (e.g., standard random access memory (RAM), an optical disc, a universal serial bus (USB) drive, or the like) having computer-readable program code embodied therein, wherein the computer-readable program code is adapted to be executed by the one or more processors 702 (e.g., working in connection with an operating system) to implement a user interface method as described below. In this regard, the program code may be implemented in any desired language, and may be implemented as machine code, assembly code, byte code, interpretable source code or the like (e.g., via C, C++, Java, Actionscript, Objective-C, Javascript, CSS, XML, and others).

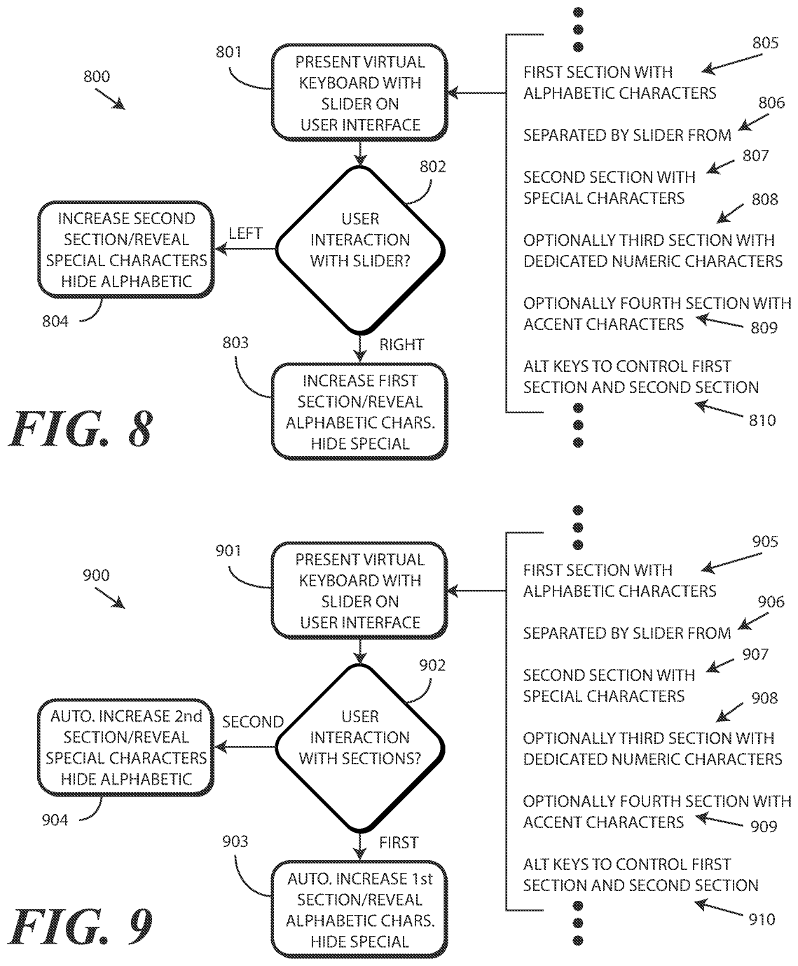

Turning now to FIG. 8, illustrated therein is one explanatory method 800 for an electronic device (such as the electronic device (700) of FIG. 7) to present and modify a virtual keyboard in accordance with one or more embodiments of the disclosure. Beginning at step 801, the method 800 presents a virtual keyboard comprising a first section 805 comprising a first plurality of virtual keys corresponding to a plurality of alphabetic characters separated by a translatable slider 806 from a second section 807 comprising a second plurality of virtual keys corresponding to a plurality of special characters.

In one or more embodiments, the virtual keyboard presented at step 801 comprises a third section 808 depicting a third plurality of virtual keys corresponding to a plurality of numeric characters. In one or more embodiments, the third section 808 remains unchanged regardless of where the translatable slider is positioned. In one or more embodiments, the virtual keyboard presented at step 801 comprises a fourth section 809 comprising a fourth plurality of virtual keys dedicated to one or both of accents or accent characters. The virtual keyboard presented at step 801 can also comprise alternate virtual keys 810 associated with the first section 805 and/or second section 807. Illustrating by example, the virtual keyboard presented at step 801 can comprise a first alternate virtual key associated with the first section 805 and a second alternate virtual key associated with the second section 807.

At decision 802, the method 800 determines whether a user has interacted with the translatable slider. In one or more embodiments, the virtual keyboard presented at step 801 comprises directional virtual keys for the translatable slider that are operable to translate the translatable slider left and right to expand the first section 805 and contract the second section 807 or vice versa. Decision 802 can determine whether these directional virtual keys receive user input in the form of touch input or “hold and drag” input.

In one or more embodiments, when decision 802 detects touch input interacting with the translatable slider, the method 800 can manipulate the translatable slider at step 803 and step 804. Illustrating by example, at step 803 the method 800 can increase the area occupied by the first section 805 to reveal additional virtual keys corresponding to additional alphabetic characters while decreasing the area occupied by the second section 807 and reducing the number of virtual keys corresponding to special characters. Examples of this step 803 were shown above with reference to FIGS. 2-3.

Alternatively, when the touch input causes the translatable slider to move in the opposite direction, at step 804 the method 800 can increase the area occupied by the second section 807 to reveal additional virtual keys corresponding to additional special characters while reducing the area occupied by the first section 805 to reduce the number of virtual keys corresponding to alphabetic characters. An example of this was shown above with reference to FIG. 6.

Turning now to FIG. 9, illustrated therein is another explanatory method 900 for an electronic device (such as the electronic device (700) of FIG. 7) to present and modify a virtual keyboard in accordance with one or more embodiments of the disclosure. In contrast to the manual method (800) of FIG. 8 where a user interacted with a translatable slider to manually cause the area occupied by the first section (805) or the second section (807) to change, the method 900 of FIG. 9 makes these changes automatically.

Beginning at step 901, the method 900 presents a virtual keyboard comprising a first section 905 comprising a first plurality of virtual keys corresponding to a plurality of alphabetic characters separated by a translatable slider 906 from a second section 907 comprising a second plurality of virtual keys corresponding to a plurality of special characters.

In one or more embodiments, the virtual keyboard presented at step 901 comprises a third section 908 depicting a third plurality of virtual keys corresponding to a plurality of numeric characters. In one or more embodiments, the third section 908 remains unchanged regardless of where the translatable slider is positioned. In one or more embodiments, the virtual keyboard presented at step 901 comprises a fourth section 909 comprising a fourth plurality of virtual keys dedicated to one or both of accents or accent characters. The virtual keyboard presented at step 901 can also comprise alternate virtual keys 910 associated with the first section 905 and/or second section 907. Illustrating by example, the virtual keyboard presented at step 901 can comprise a first alternate virtual key associated with the first section 905 and a second alternate virtual key associated with the second section 907.

At decision 902, the method 900 determines whether a user has interacted with either the virtual keys in the first section 905 or the virtual keys in the second section 907. Illustrating by example, the user may interact with the first plurality of virtual keys corresponding to the alphabetic characters. Alternatively, the user may interact with the second plurality of virtual keys corresponding to the special characters. Either is detected at decision 902.

In one or more embodiments, when decision 902 detects touch input interacting with either the virtual keys in the first section 905 or the virtual keys in the second section 907, the method 900 can automatically manipulate the translatable slider at step 903 and step 904. Illustrating by example, at step 903 the method 900 can increase the area occupied by the first section 905 to reveal additional virtual keys corresponding to additional alphabetic characters while decreasing the area occupied by the second section 907 and reducing the number of virtual keys corresponding to special characters. Examples of this step 903 were shown above with reference to FIGS. 2-3.

Alternatively, with the touch input interacts with the plurality of virtual keys corresponding to the special characters, at step 904 the method 900 can increase the area occupied by the second section 907 to reveal additional virtual keys corresponding to additional special characters while reducing the area occupied by the first section 905 to reduce the number of virtual keys corresponding to alphabetic characters. An example of this was shown above with reference to FIG. 6.

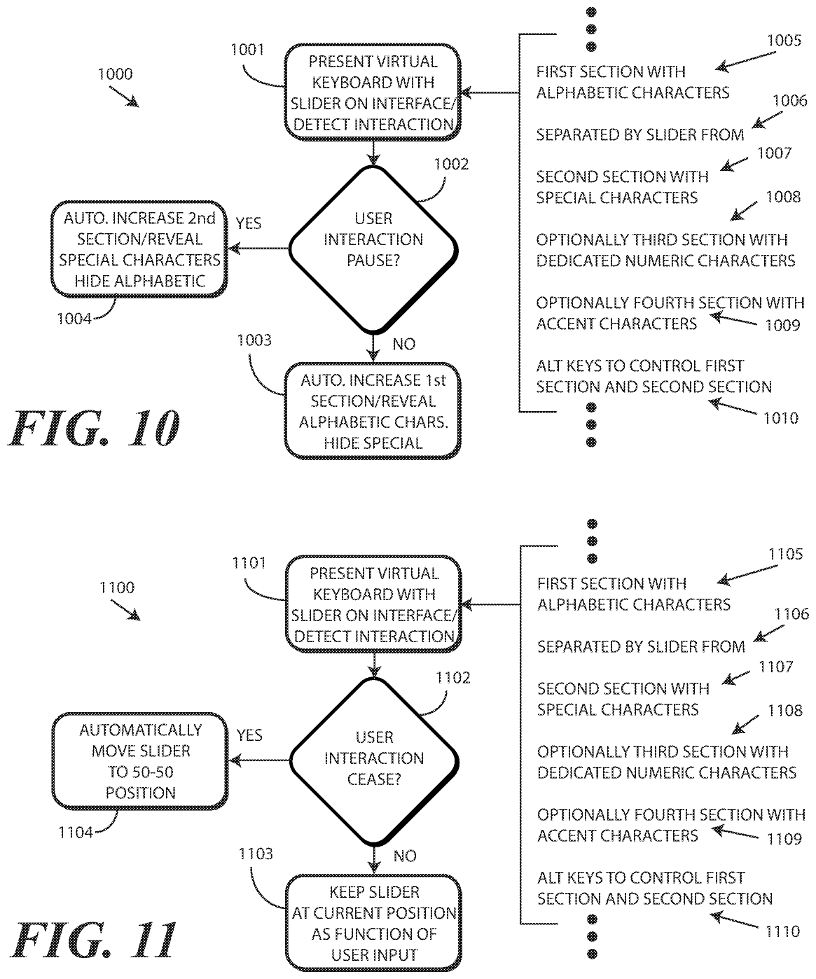

Turning now to FIG. 10, illustrated therein is another explanatory method 1000 for an electronic device (such as the electronic device (700) of FIG. 7) to present and modify a virtual keyboard in accordance with one or more embodiments of the disclosure. The method 1000 of FIG. 10 presumes that after the presentation of a virtual keyboard occurs at step 1001, a user interacts with either the first section 1005 comprising a first plurality of virtual keys corresponding to a plurality of alphabetic characters or a second section 1007 comprising a second plurality of virtual keys corresponding to a plurality of special characters. Illustrating by example, a user may interact with the first section 1005 by typing the first part of an email address. In accordance with the method (900) of FIG. 9, this automatically causes a translatable slider 1006 to move to expand the first section 1005 while reducing the area occupied by the second section 1007 as previously described.

As before, at step 1001 the method 1000 presents a virtual keyboard comprising a first section 1005 comprising a first plurality of virtual keys corresponding to a plurality of alphabetic characters separated by a translatable slider 1006 from a second section 1007 comprising a second plurality of virtual keys corresponding to a plurality of special characters.

In one or more embodiments, the virtual keyboard presented at step 1001 comprises a third section 1008 depicting a third plurality of virtual keys corresponding to a plurality of numeric characters. In one or more embodiments, the third section 1008 remains unchanged regardless of where the translatable slider is positioned. In one or more embodiments, the virtual keyboard presented at step 1001 comprises a fourth section 1009 comprising a fourth plurality of virtual keys dedicated to one or both of accents or accent characters. The virtual keyboard presented at step 1001 can also comprise alternate virtual keys 1010 associated with the first section 1005 and/or second section 1007. Illustrating by example, the virtual keyboard presented at step 1001 can comprise a first alternate virtual key associated with the first section 1005 and a second alternate virtual key associated with the second section 1007.

As noted above, the method 1000 of FIG. 10 presumes that after the presentation of a virtual keyboard occurs at step 1001, a user interacts with either the first section 1005 comprising a first plurality of virtual keys corresponding to a plurality of alphabetic characters or a second section 1007 comprising a second plurality of virtual keys corresponding to a plurality of special characters. Illustrating by example, if the person is typing the first name of an email address, the user would interact with the first section 1005 comprising the first plurality of virtual keys corresponding to the plurality of alphabetic characters. In accordance with the method (900) of FIG. 9, this automatically causes a translatable slider 1006 to move to expand the first section 1005 and decrease the second section 1007 as previously described.

At decision 1002, the method 1000 determines whether a user has paused the interaction with either the virtual keys in the first section 1005 or the virtual keys in the second section 1007. In one or more embodiments, decision 1002 determines whether there has been a cessation in the user input interacting with the virtual keys of the first section 1005 or the virtual keys in the second section 1007 for at least a predefined pause duration threshold, one example of which is thirty milliseconds. This may occur when, for example, the user gets through the first name of the email address and begins looking for a necessary special character such as the “@” virtual key.

In one or more embodiments, when decision 1002 detects a cessation of touch input interacting with either the virtual keys in the first section 1005 or the virtual keys in the second section 1007, the method 1000 can automatically manipulate the translatable slider at step 1003 and step 1004 to contract the section the user is interacting with and expand the other section. For instance, if the user pauses for the predefined pause duration threshold when typing the first name of the email address by interacting with the plurality of virtual keys corresponding to the plurality of alphabetic characters in the first section 1005, step 1003 can comprise moving the translatable slider 1006 to reduce the first section 1005 and expand the second section 1007 so that the user can find the “@” key. Similarly, if the user has struck the virtual key corresponding to the “@,” key and again pauses for the predefined pause duration threshold, step 1004 can comprise moving the translatable slider 1006 to reduce the second section 1007 and again increase the first section 1005. Alternatively, the translatable slider 1006 can be returned to the default position at either step 1003 or step 1004. In one or more embodiments, the default position is centrally disposed along the virtual keyboard.

Turning now to FIG. 11, illustrated therein is another explanatory method 1100 for an electronic device (such as the electronic device (700) of FIG. 7) to present and modify a virtual keyboard in accordance with one or more embodiments of the disclosure. The method 1100 of FIG. 11 presumes that after the presentation of a virtual keyboard occurs at step 1101, a user interacts with either the first section 1105 comprising a first plurality of virtual keys corresponding to a plurality of alphabetic characters or a second section 1107 comprising a second plurality of virtual keys corresponding to a plurality of special characters. In accordance with the method (900) of FIG. 9, this automatically causes a translatable slider 1106 to move to expand the first section 1105 or the second section 1107 as previously described.

As before, at step 1101 the method 1100 presents a virtual keyboard comprising a first section 1105 comprising a first plurality of virtual keys corresponding to a plurality of alphabetic characters separated by a translatable slider 1106 from a second section 1107 comprising a second plurality of virtual keys corresponding to a plurality of special characters.

In one or more embodiments, the virtual keyboard presented at step 1101 comprises a third section 1108 depicting a third plurality of virtual keys corresponding to a plurality of numeric characters. In one or more embodiments, the third section 1108 remains unchanged regardless of where the translatable slider is positioned. In one or more embodiments, the virtual keyboard presented at step 1101 comprises a fourth section 1109 comprising a fourth plurality of virtual keys dedicated to one or both of accents or accent characters. The virtual keyboard presented at step 1101 can also comprise alternate virtual keys 1110 associated with the first section 1105 and/or second section 1107. Illustrating by example, the virtual keyboard presented at step 1101 can comprise a first alternate virtual key associated with the first section 1105 and a second alternate virtual key associated with the second section 1107.

As noted above, the method 1100 of FIG. 11 presumes that after the presentation of a virtual keyboard occurs at step 1101, a user interacts with either the first section 1105 comprising a first plurality of virtual keys corresponding to a plurality of alphabetic characters or a second section 1107 comprising a second plurality of virtual keys corresponding to a plurality of special characters. In accordance with the method (900) of FIG. 9, this automatically causes a translatable slider 1106 to move to expand the first section 1105 or the second section 1107 as previously described.

At decision 1102, the method 1100 determines whether a user has paused the interaction with either the virtual keys in the first section 1105 or the virtual keys in the second section 1107. In one or more embodiments, decision 1102 determines whether there has been a cessation in the user input interacting with the virtual keys of the first section 1105 or the virtual keys in the second section 1107 for at least a predefined cessation duration threshold, one example of which is one hundred milliseconds.

In one or more embodiments, when decision 1102 detects a cessation of touch input interacting with either the virtual keys in the first section 1105 or the virtual keys in the second section 1107, the method 1100 can automatically manipulate the translatable slider at step 1103 and step 1104 by returning it to a default position. In one or more embodiments, the default position is centrally disposed along the virtual keyboard.

Illustrating by example, at step 1103 the method 1100 can decrease the area occupied by the first section 1105 to conceal one or more virtual keys corresponding to additional alphabetic characters while increasing the area occupied by the second section 1107 and increasing the number of virtual keys corresponding to special characters. This returns the virtual keyboard to the embodiment shown above in FIG. 1.

Alternatively, with the touch input ceases interacting with the plurality of virtual keys corresponding to the special characters, at step 1104 the method 1100 can decrease the area occupied by the second section 1107 to conceal one or more virtual keys corresponding to special characters while increasing the area occupied by the first section 1105 to increase the number of virtual keys corresponding to alphabetic characters. Again, this would return the virtual keyboard to the embodiment of FIG. 1 described above.

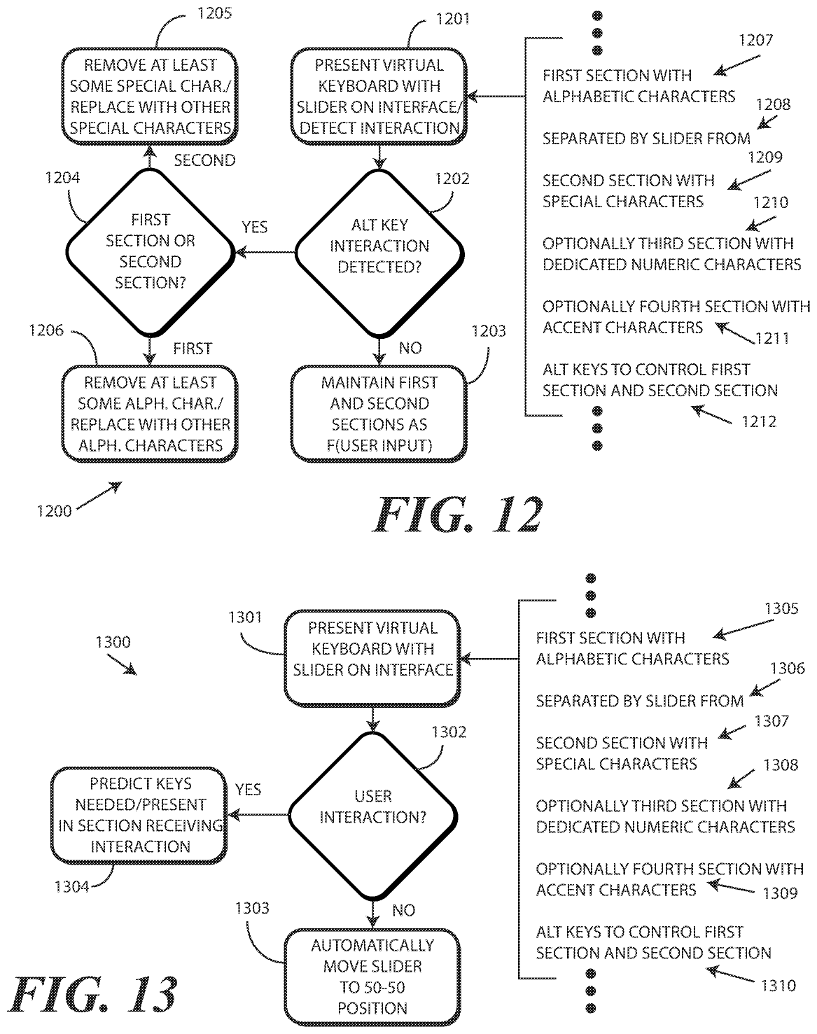

Turning now to FIG. 12, illustrated therein is another explanatory method 1200 for an electronic device (such as the electronic device (700) of FIG. 7) to present and modify a virtual keyboard in accordance with one or more embodiments of the disclosure when alternate virtual keys are touched. As before, at step 1201 the method 1200 presents a virtual keyboard comprising a first section 1207 comprising a first plurality of virtual keys corresponding to a plurality of alphabetic characters separated by a translatable slider 1208 from a second section 1209 comprising a second plurality of virtual keys corresponding to a plurality of special characters.

In one or more embodiments, the virtual keyboard presented at step 1201 comprises a third section 1210 depicting a third plurality of virtual keys corresponding to a plurality of numeric characters. In one or more embodiments, the third section 1210 remains unchanged regardless of where the translatable slider is positioned. In one or more embodiments, the virtual keyboard presented at step 1201 comprises a fourth section 1211 comprising a fourth plurality of virtual keys dedicated to one or both of accents or accent characters. The virtual keyboard presented at step 1201 can also comprise alternate virtual keys 1212 associated with the first section 1207 and/or second section 1209. Illustrating by example, the virtual keyboard presented at step 1201 can comprise a first alternate virtual key associated with the first section 1207 and a second alternate virtual key associated with the second section 1209.

At decision 1202, the method 1200 determines whether there has been interaction with a first alternate virtual key corresponding to the first section 1207 or a second alternate virtual key corresponding to the second section 1209. Where this has not occurred, the first section 1207 and the second section 1209 remain unchanged at step 1203.

Where either first alternate virtual key corresponding to the first section 1207 or the second alternate virtual key corresponding to the second section 1207 has been interacted with, the method 1200 moves to decision 1204 where the method 1200 determines whether the user interaction was with the first alternate virtual key corresponding to the first section 1207 or the second alternate virtual key corresponding to the second section 1209.

Where the user interaction was with the first alternate virtual key corresponding to the first section 1207, step 1206 replaces at least some of the virtual keys corresponding to the alphabetic characters in the first plurality of virtual keys with other virtual keys corresponding to other alphabetic characters. By contrast, when the user interaction is with the second alternate virtual key corresponding to the second section 1209, step 1205 replaces at least some of the virtual keys corresponding to the special characters with other virtual keys corresponding to other special characters. The operation of step 1205 and step 1206 was illustrated above in FIGS. 4 and 5.

Turning now to FIG. 13, illustrated therein is another explanatory method 1300 for an electronic device (such as the electronic device (700) of FIG. 7) to present and modify a virtual keyboard in accordance with one or more embodiments of the disclosure when alternate virtual keys are touched. As before, at step 1301 the method 1300 presents a virtual keyboard comprising a first section 1207 comprising a first plurality of virtual keys corresponding to a plurality of alphabetic characters separated by a translatable slider 1306 from a second section 1307 comprising a second plurality of virtual keys corresponding to a plurality of special characters.

In one or more embodiments, the virtual keyboard presented at step 1301 comprises a third section 1308 depicting a third plurality of virtual keys corresponding to a plurality of numeric characters. In one or more embodiments, the third section 1308 remains unchanged regardless of where the translatable slider is positioned. In one or more embodiments, the virtual keyboard presented at step 1301 comprises a fourth section 1309 comprising a fourth plurality of virtual keys dedicated to one or both of accents or accent characters. The virtual keyboard presented at step 1301 can also comprise alternate virtual keys 1310 associated with the first section 1305 and/or second section 1307. Illustrating by example, the virtual keyboard presented at step 1301 can comprise a first alternate virtual key associated with the first section 1305 and a second alternate virtual key associated with the second section 1307.

At decision 1302, the method 1300 determines whether there has been interaction with the first plurality of virtual keys corresponding to the alphabetic characters in the first section 1305 or the second plurality of virtual keys corresponding to special characters in the second section 1309. Where this has not occurred, the translatable slider 1306 returns to the default position at step 1303 leaving the area occupied by the first section 1305 and the area occupied by the second section 1307 substantially equal.

However, when there is interaction with the first plurality of virtual keys corresponding to the alphabetic characters in the first section 1305 or the second plurality of virtual keys corresponding to special characters in the second section 1307, step 1304 predictively selects which alphabetic characters or special characters to present next based upon the most likely alphabetic characters or special characters that will be needed. In one or more embodiments, step 1304 comprises selecting either a first plurality of virtual keys for presentation in the first section 1305 or a second plurality of virtual keys for presentation in the second section 1307 as a function of the previous user interaction with the corresponding section. Thus, if a user interacts with the first section 1305 by typing “cantelo,” the letters “u,” “p,” and “e,” will be presented in the first section 1305 at step 1304. By contrast, if a user is interacting with the second section 1307 and types “(,” at step 1304 the “)” special characters will be presented in the second section 1307, and so forth.

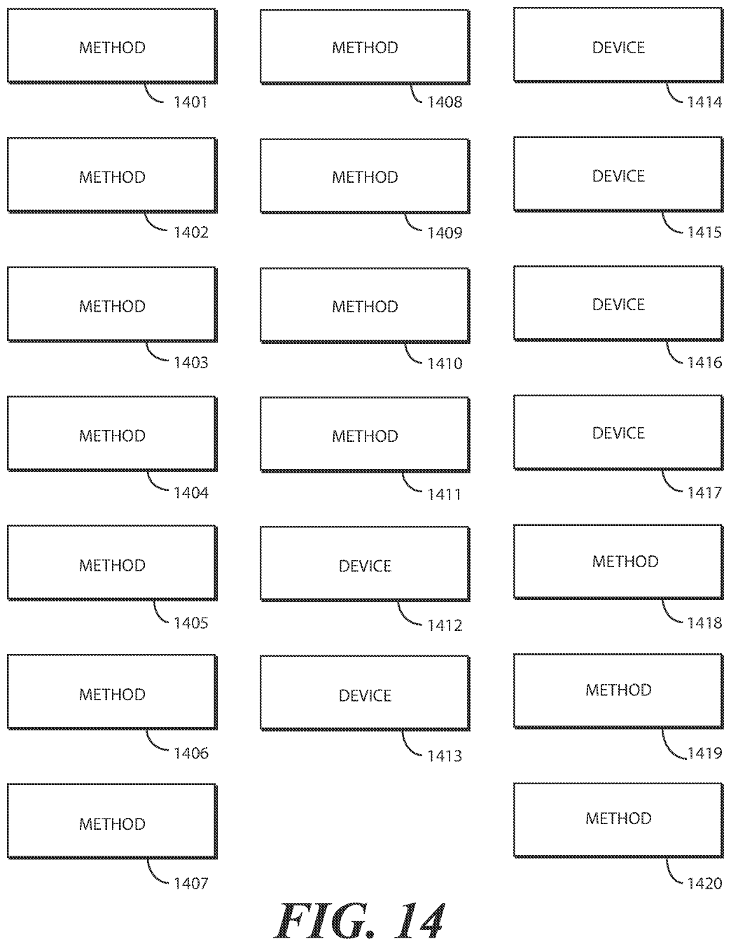

Turning now to FIG. 14, illustrated therein are various embodiments of the disclosure. The embodiments of FIG. 14 are shown as labeled boxes in FIG. 14 due to the fact that the individual components of these embodiments have been illustrated in detail in FIGS. 1-13, which precede FIG. 14. Accordingly, since these items have previously been illustrated and described, their repeated illustration is no longer essential for a proper understanding of these embodiments. Thus, the embodiments are shown as labeled boxes.

At 1401, a method in an electronic device presents, by one or more processors on a user interface of the electronic device, a virtual keyboard. At 1401, the virtual keyboard comprises a first section comprising a first plurality of virtual keys corresponding to a plurality of alphabetic characters separated by a translatable slider from a second section comprising a second plurality of virtual keys corresponding to a plurality of special characters.

At 1401, the method receives, by a touch sensor operable with the one or more processors, touch input at the user interface interacting with the virtual keyboard. At 1401, the method manipulates the translatable slider to one of increase an area occupied by the first section while decreasing another area occupied by the second section or increase the other area occupied by the second section while decreasing the area occupied by the first section.

At 1402, the increasing of the area occupied by the first section of 1401 exposes additional virtual keys corresponding to additional alphabetic characters while decreasing the other area occupied by the second section reduces a number of virtual keys corresponding to the special characters in the plurality of virtual keys corresponding to the plurality of special characters. At 1403, the increasing the other area occupied by the second section of 1401 exposes additional virtual keys corresponding to additional special characters while decreasing the area occupied by the first section reduces a number of virtual keys corresponding to the alphabetic characters in the plurality of virtual keys corresponding to the plurality of alphabetic characters.

At 1404, the user interface of 1401 interacts with the plurality of virtual keys corresponding to the alphabetic characters in the first section. At 1404, the manipulating the translatable slider occurs automatically to increase the area occupied by the first section while decreasing the other area occupied by the second section.

At 1405, the method of 1404 further comprises detecting, by the one or more processors, a cessation in the user input exceeding a predefined cessation duration threshold. At 1405, the method comprises returning the translatable slider to a default position. At 1406, the default position of 1405 is centrally disposed along the virtual keyboard such that the area occupied by the first section and the other area occupied by the second section are substantially equal.

At 1407, the method of 1405 further comprises detecting, by the one or more processors, a pause in the user input that exceeds a predefined pause duration threshold but is less than the predefined cessation duration threshold. At 1407, the method comprises manipulating the translatable slider to increase the other area occupied by the second section while decreasing the area occupied by the first section.

At 1408, the virtual keyboard of 1405 further comprises a first alternate virtual key associated with the first section and a second alternate virtual key associated with the second section. At 1408, the method further comprises one or both of detecting, by the touch sensor, additional user input interacting with the first alternate virtual key associated with the first section and replacing at least some of the virtual keys corresponding to the alphabetic characters in the first plurality of virtual keys with other virtual keys corresponding to other alphabetic characters and/or detecting, by the touch sensor, additional user input interacting with the second alternate virtual key associated with the second section and replacing at least some of the virtual keys corresponding to the special characters in the second plurality of virtual keys with other virtual keys corresponding to other special characters.

At 1409, the virtual keyboard of 1401 further comprises a third section depicting a third plurality of virtual keys corresponding to a plurality of numeric characters. At 1409, the third section remains unchanged regardless of where the translatable slider is positioned.

At 1410, the virtual keyboard of 1409 further comprises a fourth section comprising a fourth plurality of virtual keys dedicated to one or both of accents or accent characters. At 1411, the virtual keyboard of 1401 further comprises directional virtual keys for the translatable slider. At 1411, the method further comprises detecting, by the touch sensor, additional user input interacting with the directional virtual keys for the translatable slider and moving the translatable slider in a direction corresponding to a directional key with which the user input interacted.

At 1412, an electronic device comprises a user interface configured to display content and receive input from a user and one or more processors operable with the user interface. At 1412, the one or more processors cause the user interface to display a virtual keyboard.

At 1412, the virtual keyboard comprises a first section comprising a first plurality of virtual keys corresponding to a plurality of alphabetic characters and a second section comprising a second plurality of virtual keys corresponding to a plurality of special characters. At 1412, the first section and the second section are separated by a translatable slider.

At 1412, when the translatable slider is manipulated by input from a user, it either increases an area occupied by the first section while decreasing another area occupied by the second section or increases the other area occupied by the second section while decreasing the area occupied by the first section. At 1412, the one or more processors can automatically move the slider, thereby increasing the area occupied by the first section while decreasing the another area occupied by the second section when the input from the user interacts with virtual keys of the first plurality of virtual keys or increasing the other area occupied by the second section while decreasing the area occupied by the first section when the input from the user interacts with other virtual keys of the second plurality of virtual keys.

At 1413, the one or more processors of 1412 return the slider to a midpoint leaving the area occupied by the first section and the other area occupied by the second section substantially equal when the input from the user ceases interacting with the virtual keyboard for at least a predefined cessation duration threshold. At 1414, the one or more processors of 1413 automatically move the slider to increase the other area occupied by the second section while decreasing the area occupied by the first section when the input from the user pauses for a duration between a predefined pause duration threshold and the predefined cessation duration threshold.

At 1415, the alphabetic characters of 1412 and the special characters of 1412 represent characters from a language of an indigenous people. At 1416, the one or more processors of 1412 cause the user interface to present a third section comprising a third plurality of virtual keys corresponding to numeric characters regardless of where the translatable slider is positioned.

At 1417, the virtual keyboard of 1412 further comprises an alternate virtual key associated with the second section. At 1417, the one or more processors change virtual keys of the second plurality of virtual keys when the input from the user interacts with the alternate virtual key.

At 1418, a method for an electronic device comprises detecting, with a user interface, user input interacting with a virtual keyboard comprising a first section comprising a first plurality of virtual keys corresponding to a plurality of alphabetic characters separated by a translatable slider from a second section comprising a second plurality of virtual keys corresponding to a plurality of special characters. At 1418, the method comprises automatically, by one or more processors, causing the translatable slider to translate to one of increase an area occupied by the first section while decreasing another area occupied by the second section or increase the other area occupied by the second section while decreasing the area occupied by the first section.

At 1419, the translatable slider of 1418 is oriented vertically between the first section and the second section. At 1419, the one or more processors of 1418 automatically cause the translatable slider to translate by moving horizontally across the virtual keyboard. At 1420, the method of 1418 further comprises selecting, by the one or more processors, the first plurality of virtual keys for presentation in the first section as a function of past user interaction with the first section.

In the foregoing specification, specific embodiments of the present disclosure have been described. However, one of ordinary skill in the art appreciates that various modifications and changes can be made without departing from the scope of the present disclosure as set forth in the claims below. Thus, while preferred embodiments of the disclosure have been illustrated and described, it is clear that the disclosure is not so limited. Numerous modifications, changes, variations, substitutions, and equivalents will occur to those skilled in the art without departing from the spirit and scope of the present disclosure as defined by the following claims. For example

Accordingly, the specification and figures are to be regarded in an illustrative rather than a restrictive sense, and all such modifications are intended to be included within the scope of present disclosure. The benefits, advantages, solutions to problems, and any element(s) that may cause any benefit, advantage, or solution to occur or become more pronounced are not to be construed as a critical, required, or essential features or elements of any or all the claims. The disclosure is defined solely by the appended claims including any amendments made during the pendency of this application and all equivalents of those claims as issued.

What is claimed is:

1. A method in an electronic device, the method comprising:
presenting, by one or more processors on a user interface of the electronic device, a virtual keyboard comprising:
a first section comprising a first plurality of virtual keys corresponding to a plurality of alphabetic characters separated by a translatable slider from a second section comprising a second plurality of virtual keys corresponding to a plurality of special characters;
receiving, by a touch sensor operable with the one or more processors, touch input at the user interface interacting with the virtual keyboard; and
manipulating the translatable slider to one of:
increase an area occupied by the first section while decreasing another area occupied by the second section; or
increase the another area occupied by the second section while decreasing the area occupied by the first section.

2. The method of claim 1, wherein increasing the area occupied by the first section exposes additional virtual keys corresponding to additional alphabetic characters while decreasing the another area occupied by the second section reduces a number of virtual keys corresponding to the special characters in the second plurality of virtual keys corresponding to the plurality of special characters.

3. The method of claim 1, wherein increasing the another area occupied by the second section exposes additional virtual keys corresponding to additional special characters while decreasing the area occupied by the first section reduces a number of virtual keys corresponding to the alphabetic characters in the first plurality of virtual keys corresponding to the plurality of alphabetic characters.

4. The method of claim 1, wherein:
the touch input interacts with the first plurality of virtual keys corresponding to the alphabetic characters in the first section; and
the manipulating the translatable slider occurs automatically to increase the area occupied by the first section while decreasing the another area occupied by the second section.

5. The method of claim 4, further comprising:
detecting, by the one or more processors, a cessation in the touch input exceeding a predefined cessation duration threshold; and
returning the translatable slider to a default position.

6. The method of claim 5, the default position being centrally disposed along the virtual keyboard such that the area occupied by the first section and the another area occupied by the second section are substantially equal.

7. The method of claim 5, further comprising:
detecting, by the one or more processors, a pause in the touch input that exceeds a predefined pause duration threshold but is less than the predefined cessation duration threshold; and
manipulating the translatable slider to increase the another area occupied by the second section while decreasing the area occupied by the first section.

8. The method of claim 5, wherein the virtual keyboard further comprises a first alternate virtual key associated with the first section and a second alternate virtual key associated with the second section, further comprising one or both of:
detecting, by the touch sensor, additional user input interacting with the first alternate virtual key associated with the first section and replacing at least some virtual keys corresponding to the alphabetic characters in the first plurality of virtual keys with other virtual keys corresponding to other alphabetic characters; and/or
detecting, by the touch sensor, additional user input interacting with the second alternate virtual key associated with the second section and replacing at least some virtual keys corresponding to the special characters in the second plurality of virtual keys with other virtual keys corresponding to other special characters.

9. The method of claim 1, the virtual keyboard further comprising a third section depicting a third plurality of virtual keys corresponding to a plurality of numeric characters, wherein the third section remains unchanged regardless of where the translatable slider is positioned.

10. The method of claim 9, the virtual keyboard further comprising a fourth section comprising a fourth plurality of virtual keys dedicated to one or both of accents and/or accent characters.

11. The method of claim 1, the virtual keyboard further comprising directional virtual keys for the translatable slider, further comprising:
detecting, by the touch sensor, additional user input interacting with the directional virtual keys for the translatable slider; and
moving the translatable slider in a direction corresponding to a directional key with which the touch input interacted.

12. An electronic device, comprising:
a user interface configured to display content and receive input from a user;
one or more processors operable with the user interface, wherein the one or more processors;
cause the user interface to display a virtual keyboard comprising:
a first section comprising a first plurality of virtual keys corresponding to a plurality of alphabetic characters; and
a second section comprising a second plurality of virtual keys corresponding to a plurality of special characters;
wherein the first section and the second section are separated by a translatable slider that, when manipulated by the input from the user, one of:
increases an area occupied by the first section while decreasing another area occupied by the second section; or
increases the another area occupied by the second section while decreasing the area occupied by the first section; and
automatically move the translatable slider, thereby:
increasing the area occupied by the first section while decreasing the another area occupied by the second section when the input from the user interacts with virtual keys of the first plurality of virtual keys; or
increasing the another area occupied by the second section while decreasing the area occupied by the first section when the input from the user interacts with other virtual keys of the second plurality of virtual keys.

13. The electronic device of claim 12, wherein the one or more processors return the translatable slider to a midpoint leaving the area occupied by the first section and the another area occupied by the second section substantially equal when the input from the user ceases interacting with the virtual keyboard for at least a predefined cessation duration threshold.

14. The electronic device of claim 13, wherein the one or more processors automatically move the translatable slider to increase the another area occupied by the second section while decreasing the area occupied by the first section when the input from the user pauses for a duration between a predefined pause duration threshold and the predefined cessation duration threshold.

15. The electronic device of claim 12, wherein the alphabetic characters and the special characters represent characters from a language of an indigenous people.

16. The electronic device of claim 12, wherein the one or more processors cause the user interface to present a third section comprising a third plurality of virtual keys corresponding to numeric characters regardless of where the translatable slider is positioned.

17. The electronic device of claim 12, the virtual keyboard further comprising an alternate virtual key associated with the second section, wherein the one or more processors change virtual keys of the second plurality of virtual keys when the input from the user interacts with the alternate virtual key.

18. A method for an electronic device, the method comprising:
detecting, with a user interface, user input interacting with a virtual keyboard comprising a first section comprising a first plurality of virtual keys corresponding to a plurality of alphabetic characters separated by a translatable slider from a second section comprising a second plurality of virtual keys corresponding to a plurality of special characters; and
automatically, by one or more processors, causing the translatable slider to translate to one of:
increase an area occupied by the first section while decreasing another area occupied by the second section; or
increase the another area occupied by the second section while decreasing the area occupied by the first section.

19. The method of claim 18, wherein:
the translatable slider is oriented vertically between the first section and the second section; and
the one or more processors automatically cause the translatable slider to translate by moving horizontally across the virtual keyboard.

20. The method of claim 18, further comprising selecting, by the one or more processors, the first plurality of virtual keys for presentation in the first section as a function of past user interaction with the first section.
